(19) United States
(12) Patent Application Publication
(10) Pub. No.: US 2005/0213758 A1
(43) Pub. Date: Sep. 29, 2005

(54) Efficient and compact subgroup trace representation ("XTR")

(76) Inventors: Arjen K. Lenstra, Mendham, NJ (US); Eric R. Verheul, Eindhoven (NL)

Correspondence Address: MORGAN & FINNEGAN, L.L.P., 3 World Financial Center, New York, NY, 10281-2101, US

(21) Appl. No.: 11/125,539

(22) Filed: May 9, 2005

Related U.S. Application Data
(63) Continuation of application No. 09/498,716, filed on Feb. 7, 2000, now abandoned.

(51) Int. Cl. H04L 9/00

(52) U.S. Cl. 380/44

(57) ABSTRACT

The invention is a method, system, computer program, computer program article of manufacture, and business method for providing improvements in key generation and cryptographic applications in public key cryptography, by both reducing: 1) the bit-length of public keys and other messages, thereby reducing the bandwidth requirements of telecommunications devices, such as wireless telephone sets, and 2) the computational effort required to generate keys, to encrypt/decrypt and to generate/verify digital signatures. The method of the invention determines a public key having a reduced length and a number p, using GF(p²) arithmetic to achieve GF(p⁶) security, without explicitly constructing GF(p⁶).

### RELATED PATENT APPLICATIONS

The following copending U.S. patent applications are directed to related inventions and are incorporated herein by reference.

U.S. patent application entitled “Cyclotomic Polynomial Construction Of Discrete Logarithm Cryptosystems Over Finite Fields”, application Ser. No. 08/800,669, Filed: Feb. 14, 1997, Applicant: Aijen K. Lenstra.

U.S. patent application entitled “Generating RSA Moduli Including A Predetermined Portion”, application Ser. No. 09/057,176, Filed: Apr. 8, 1998, Applicant: Arjen K. Lenstra.

### BACKGROUND OF THE INVENTION

1. Field of the Invention

The invention disclosed broadly relates to public key cryptography and more particularly relates to improvements in key generation and cryptographic applications in public key cryptography.

2. Related Art

The generation of a modulus as part of a public key according to the Rivest-Shamir-Adleman (RSA) cryptographic method is described in U.S. Pat. No. 4,405,829 (Rivest et al.), “Cryptographic Communications System and Method”, the disclosure of which is hereby incorporated by reference. In a setup phase of the RSA scheme, a participant picks two prime numbers, p and q, each having a selected number of bits, such as 512 bits, with p not equal to q. The participant keeps p and q secret. The participant computes an RSA modulus n, with n=p*q. When p and q each have 512 bits, n has 1023 or 1024 bits. The participant picks an RSA exponent e that has no factors in common with (p−1)(q−1). For efficiency purposes, the RSA exponent e is often chosen of much shorter length than the RSA modulus. When the RSA modulus n has 1024 bits, the RSA exponent e typically has at most 64 bits. The owning participant makes the public key (n, e) available to other participants.

During operational use of the RSA scheme, other participants use the public key (n, e) to encrypt messages for the participant which owns that key. The owning participant is able to decrypt messages encrypted with the public key (n, e) due to possession of the secret prime numbers p and q.

Participants must store not only the public key of other participants, but also identifying information such as the name, address, account number and so on of the participant owning each stored public key. There are problems with this situation. One problem with the present technique for using the RSA encryption scheme is that, although the RSA modulus n is 1024 bits, the amount of security provided actually corresponds to only 512 bits, since an attacker who knows one of p and q can readily obtain the other of p and q. Instead of having to store 1024 bits to obtain 512 truly secure bits, it is desirable to store far fewer bits, such as approximately 512 bits, to obtain the 512 truly secure bits.

Another problem with the present technique is that the long bit-length of the public keys imposes a significant bandwidth load on telecommunications devices, such as wireless telephone sets. It is desirable to reduce the amount of bandwidth load as much as possible.

Generating RSA moduli having a predetermined portion has been considered by Scott A. Vanstone and Robert J. Zuccherato in “Short RSA Keys and Their Generation”, J. Cryptology, 1995, volume 8, pages 101-114, the disclosure of which is hereby incorporated by reference.

In “Finding a Small Root of a Bivariate Integer Equation; Factoring with High Bits Known”, U. Maurer ed., EUROCRYPT '96 Proceedings, pages 178-189, Springer Verlag 1996, the disclosure of which is hereby incorporated by reference, Don Coppersmith has analyzed the security of the Vanstone methods, and found that all but one of Vanstone's methods provide inadequate security. Specifically, for the Vanstone methods having predetermined high order bits, the RSA modulus n is generated in such a way that somewhat more than the high order ((¼)log₂ n) bits of p are revealed to the public, which enables discovery of the factorization of the RSA modulus n, thus leaving the scheme vulnerable to attack.

### SUMMARY OF THE INVENTION

The invention disclosed provides improvements in key generation and cryptographic applications in public key cryptography, by both reducing: 1) the bit-length of public keys and other messages, thereby reducing the bandwidth requirements of telecommunications devices, such as wireless telephone sets, and 2) the computational effort required to generate keys, to encrypt/decrypt and to generate/verify digital signatures.

The method of the invention determines a public key having a reduced length and a number p, using GF(p) or GF(p²) arithmetic to achieve GF(p⁶) security, without explicitly constructing GF(p⁶). The method includes the step of selecting a number p and a prime number q that is a divisor of p²−p.+1. Then the method selects an element g of order q in GF(p⁶), where g and its conjugates can be represented by B, where F_{g}(X)=X−BX²+B^{p}X−1 and the roots of F_{g}(X) are g, g^{p-1}, and g^{-p}. Then the method represents the powers of g using their trace over the field GF(p²). The method then selects a private key. The method then computes a public key as a function of g and the private key. The public key can be used to encrypt a message and the public and private key can be used to decrypt the message. The public and private key can be used for signing a message and the public key can be used for verifying the signature. A Diffie-Hellman key exchange or other related scheme can be conducted using the public key generated by the method. The resulting invention reduces the bit-length of public keys and other messages, thereby reducing the bandwidth requirements of telecommunications devices, and reduces the computational effort required to encrypt/decrypt and to generate/verify digital signatures.

### BRIEF DESCRIPTION OF THE DRAWINGS

FIG. 1 is a diagram of an example network in which the invention can be carried out.

FIG. 2 is a functional block diagram of an example server computer in the network of FIG. 1, in which the invention can be carried out.

FIG. 3 is a functional block diagram of an example client computer in the network of FIG. 1, in which the invention can be carried out.

FIG. 4 is a flow diagram of the method performed in a server and/or a client in the network of FIG. 1, in accordance with the invention.

FIG. 5 is a flow diagram of the preferred embodiment of the method for selection of “p”, and “q”, as shown in section 2.1.

FIG. 6 is a flow diagram of the arithmetic method to support key generation, as shown in section 2.4.4.

FIG. 7 is a flow diagram of the method of key generation, as shown in section 3.3.8.

FIG. 8 is a flow diagram of the method of Diffie Hellman key exchange, as shown in section 4.1, using keys generated by the method of FIG. 7.

FIG. 9 is a flow diagram of the method of ElGamal encryption, as shown in section 4.2, using keys generated by the method of FIG. 7.

FIG. 10A is a flow diagram of the arithmetic method to support generating digital signatures, as shown in section 2.5.3.

FIG. 10B is a flow diagram of the method of generating digital signatures, as shown in section 4.3., using keys generated by the method of FIG. 7.

### DESCRIPTION OF THE PREFERRED EMBODIMENTS

The Network and System Environment of the Invention

The invention is a method, system, computer program, computer program article of manufacture, and business method for providing improvements in key generation and cryptographic applications in public key cryptography, by both reducing: 1) the bit-length of public keys and other messages, thereby reducing the bandwidth requirements of telecommunications devices, such as wireless telephone sets, and 2) the computational effort required to generate keys, to encrypt/decrypt and to generate/verify digital signatures.

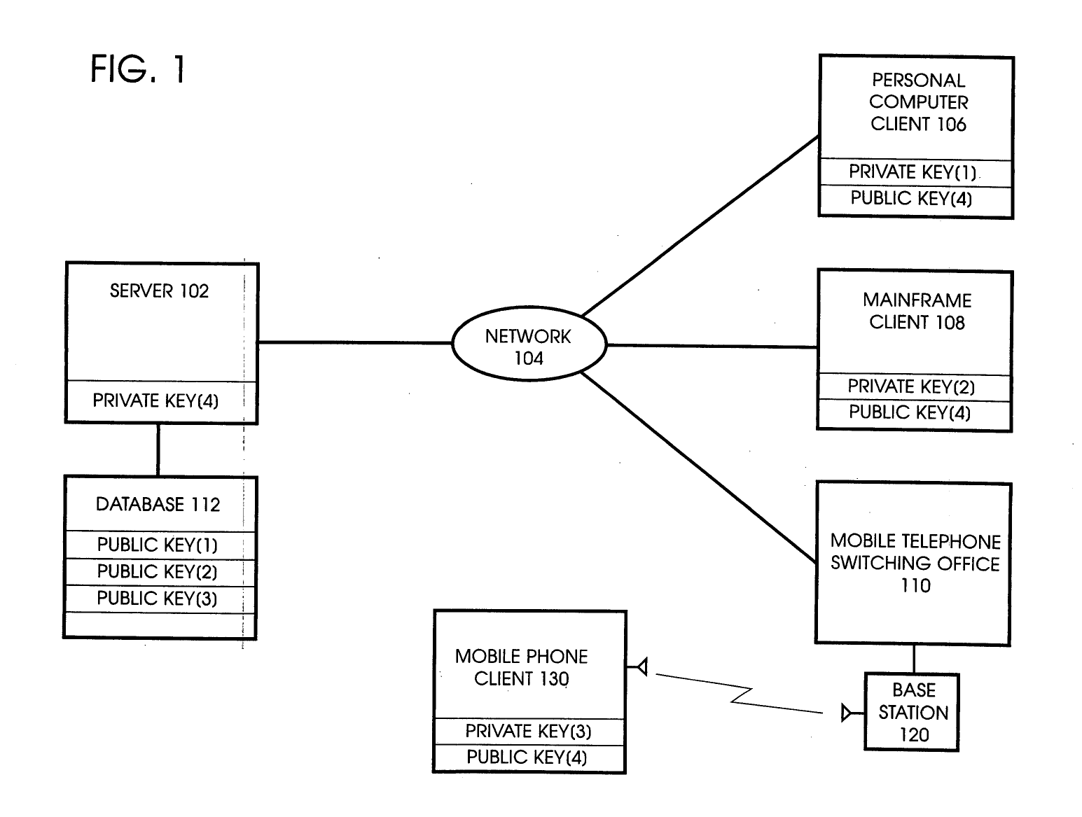

FIG. 1 is a diagram of an example network in which the invention can be carried out. The method of the invention can be performed, for example, in a server computer connected over a network to a client computer. The method can also be performed, for example, in a client computer. FIG. 1 shows a server computer 102 connected over the Internet network 104 to three client computers, the personal computer 106, the main frame computer 108, and a microprocessor in the mobile phone client 130. The mobile phone client 130 is connected via the mobile telephone switching office 110 and the radio frequency base station 120 to the network 104. A database 112 is connected to the server 102, which stores public keys labeled (1), (2), and (3). Public key (1) was generated, in accordance with the method of the invention, in the personal computer client 106, and was transmitted over the network 104 to the server 102, for storage in the database 112. Public key (2) was generated, in accordance with the method of the invention, in the main frame client 106, and was transmitted over the network 104 to the server 102, for storage in the database 112. Public key (3) was generated, in accordance with the method of the invention, in the microprocessor of the mobile phone client 130, and was transmitted to the base station 120 over its radio frequency link, and via the mobile telephone switching office 110 and the network 104 to the server 102, for storage in the database 112. Public key (4) was generated, in accordance with the method of the invention, in the server computer 102, and was transmitted over the network 104 to each of the clients 106, 108, and 130. Each client 106, 108, and 130 generated, in accordance with the method of the invention, a private key respectively labeled (1), (2), and (3) which remains stored in the respective client. The server 102 generated, in accordance with the method of the invention, a private key labeled (4) which remains stored in the server. All public keys are properly certified using standard key certification methods as can be found in the cryptographic literature, such as the Handbook of Applied Cryptography, by A. J. Menezes, P. C. van Oorschot, and S. A. Vanstone, CRC Press, 1997.

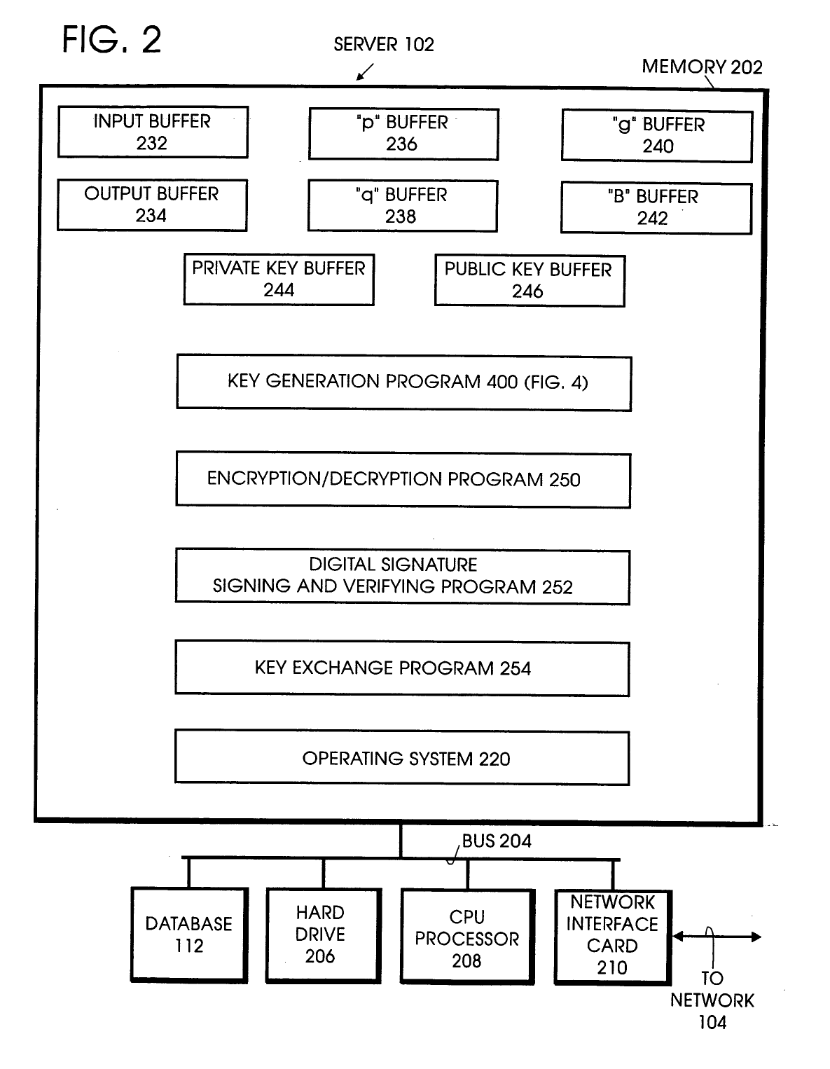

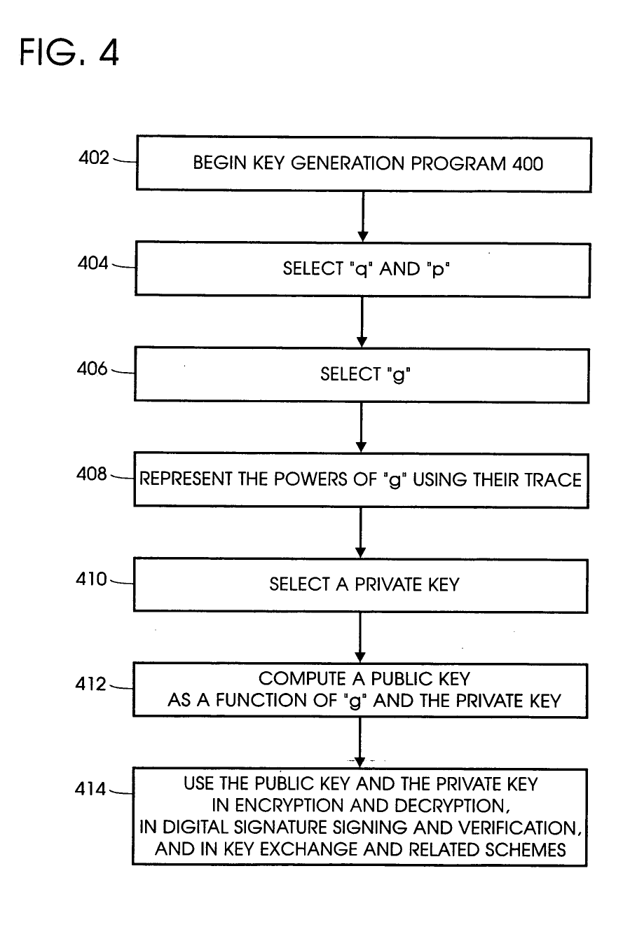

FIG. 2 is a functional block diagram of an example server computer in the network of FIG. 1, in which the invention can be carried out. The server computer 102 includes a memory 202 connected by the bus 204 to the database 112, a hard drive 206, a CPU processor 208, and a network interface card 210 which is connected to the Internet network 104. The memory 202 includes an input buffer 232 and an output buffer 234. The memory 202 also includes a “p” buffer 236, a “q” buffer 238, a “g” buffer 240, and a “B” buffer 242. See sections 1, 2, and 3, below, for a discussion of the values “p”, “q”, “g”, and “B”. The memory 202 also includes a private key buffer 244, and a public key buffer 246. The memory 202 also includes a key generation program 400, whose flow diagram is shown in FIG. 4, which operates in accordance with the method of the invention. The memory 202 also includes an encryption program 250 that uses the keys generated by the key generation program 400. The method of ElGamal encryption is described in section 4.2. The memory 202 also includes a digital signature signing and verifying program 252 that uses the keys generated by the key generation program 400. The arithmetic method to support generating digital signatures is described in section 2.5.3 and the method of generating digital signatures is described in section 4.3. The memory 202 also includes a key exchange program 254 that uses the keys generated by the key generation program 400. The method of Diffie Hellman key exchange is described in section 4.1. The memory 202 also includes an operating system program 220. The programs stored in the memory 202 are sequences of executable steps which, when executed by the CPU processor 208, perform the methods of the invention.

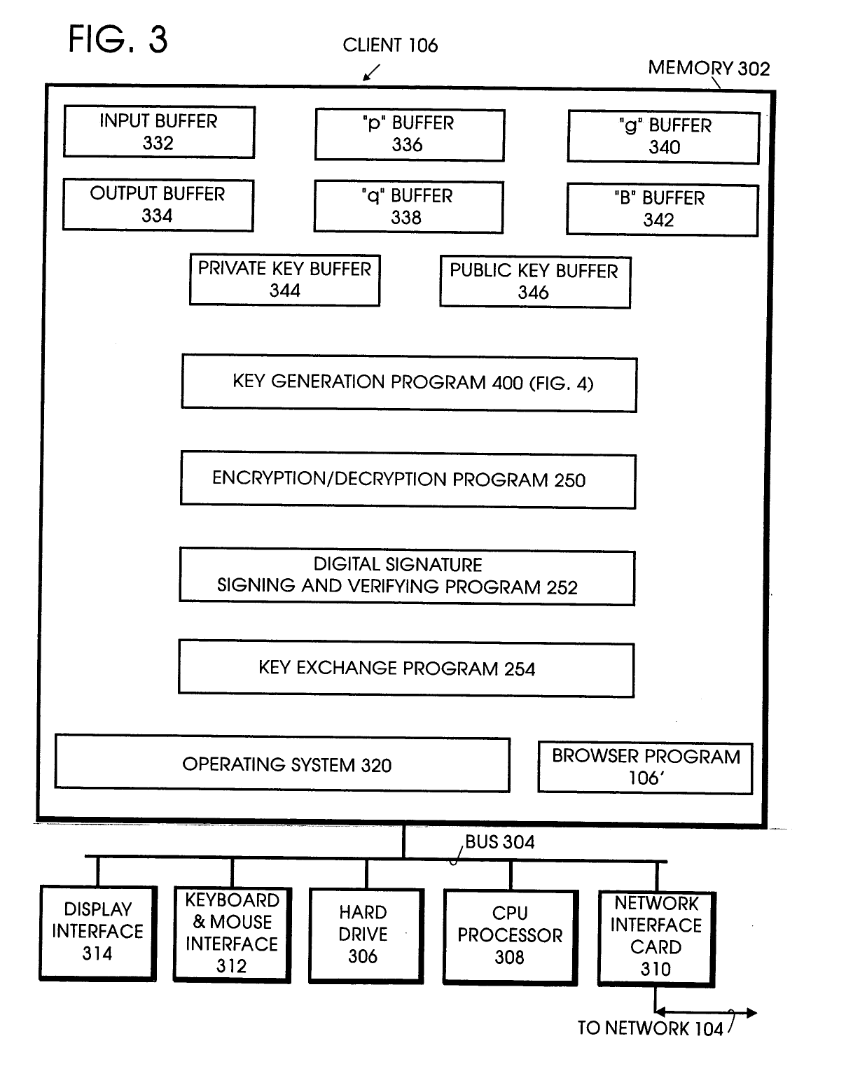

FIG. 3 is a functional block diagram of an example client computer in the network of FIG. 1, such as the client 106. The client computer 106 includes a memory 302 connected by the bus 304 to the display interface 314, the keyboard and mouse interface 312, a hard drive 306, a CPU processor 308, and a network interface card 310 which is connected to the Internet network 104. The memory 302 includes an input buffer 332, an output buffer 334, a “p” buffer 336, a “q” buffer 338, a “g” buffer 340, a “B” buffer 342, a private key buffer 344, and a public key buffer 346. The memory 302 also includes the key generation program 400, whose flow diagram is shown in FIG. 4, which operates in accordance with the method of the invention. The memory 302 also includes the encryption program 250 that uses the keys generated by the key generation program 400. The memory 302 also includes a digital signature signing and verifying program 252 that uses the keys generated by the key generation program 400. The memory 302 also includes a key exchange program 254 that uses the keys generated by the key generation program 400. The memory 302 also includes an operating system program 320 and a browser program 106′. The programs stored in the memory 302 are sequences of executable steps which, when executed by the CPU processor 308, perform the methods of the invention.

FIG. 4 is a flow diagram of the method performed in either the server computer 102 of FIG. 2, or in the clients 106, 108, and/or 130 in accordance with the invention. Program 400 is a sequence of executable steps that embody the method of FIG. 4. The method begins at 402 with the step 404 of selecting “q” and “p”. The method continues with the step 406 of selecting “g”. Then the method continues with the step 408 of representing the powers of “g” using their trace. Then the method continues with the step 410 of selecting a private key. Then the method continues with the step 412 of computing a public key as a function of “g” and the private key. See sections 1, 2, and 3, below, for a discussion of the values “p”, “q”, and “g”. Finally, the method concludes with the step 414 of using the public key and the private key in encryption and decryption, in digital signature signing and verification, and in key exchange and related applications. See section 4, below, for a discussion of these applications.

### 1. INTRODUCTION

The well known Diffie-Hellman (DH) key agreement protocol was the first practical solution to the key distribution problem, allowing two parties that have never met to establish a shared secret key by exchanging information over an open channel. In the basic DH scheme the two parties agree upon a generator g of the multiplicative group GF(p)* of a prime field GF(p) and they each send a random power of g to the other party (cf. Section 4 for a full description). Thus, assuming both parties know p and g, each party transmits about log₂(p) bits to the other party.

In [4] it was suggested that finite extension fields can be used instead of prime fields, but no direct computational or communication advantages were implied. In [8] a variant of the basic DH scheme was introduced where g generates a relatively small subgroup of GF(p)* of prime order q. This considerably reduces the computational cost of the DH scheme, but has no effect on the number of bits to be exchanged. In [2] it was shown for the first time how the use of finite extension fields and subgroups can be combined in such a way that the number of bits to be exchanged is reduced by a factor 3. More specifically, it was shown that elements of an order q subgroup of GF(p⁶)* can be represented using 2*log₂(p) bits if q divides p²−p+1. Despite its communication efficiency, the method of [2] is rather cumbersome and computationally not particularly efficient.

In this paper we present a greatly improved version of the method from [2] that achieves the same communication advantage at a much lower computational cost. Furthermore, we prove that using our method in cryptographic protocols does not affect their security. The best attacks we are aware of are Pollard's rho method in the order q subgroup, or the Discrete Logarithm variant of the Number Field Sieve in the full multiplicative group GF(p⁶)*. With primes p and q of about 1024/6≈170 bits the security of our method is equivalent to traditional subgroup systems using 170-bit subgroups and 1024-bit finite fields. But our subgroup elements can be represented using only about 2*170 bits, which is substantially less than the 1024-bits required for their traditional representation. The amount of computation required by a full exponentiation in our method is about the same as the time required by a full scalar multiplication in a 170-bit Elliptic Curve cryptosystem, and thus substantially less than the time required by a full 1024-bit RSA exponentiation. As a result our method may be regarded as a compromise between RSA and Elliptic Curve cryptosystems (ECC). We get security similar to RSA for much smaller public key sizes than RSA (though somewhat larger than ECC public keys), but we are not affected by the uncertainty of ECC security. Furthermore, key selection for our method is trivial compared to RSA, and certainly compared to ECC. Apart from its performance advantages, the most intriguing and innovative aspect of our method is that it is the first method we are aware of that uses GF(p²) arithmetic to achieve GF(p⁶) security, without explicitly constructing GF(p⁶). Denote by g an element of order q>3 dividing p²−p+1. Because p²−p+1 divides the order p⁶−1 of GF(p⁶)* this g can be thought of as a generator of an order q subgroup of GF(p⁶)*. As shown in [6], since p²−p+1 does not divide any p^{s}−1 for any integer s smaller than and dividing 6, the subgroup generated by g cannot be embedded in the multiplicative group of any true subfield of GF(p⁶) (assuming q is sufficiently large). We show, however, that arbitrary powers of g can be represented using a single element of the subfield GF(p²), that such powers can be computed using arithmetic operations in GF(p²), and that arithmetic in the extension field GF(p⁶) can be avoided. Moreover, our exponentiation method is much more efficient than other published methods to compute powers of elements of order dividing p²−p+1.

In Section 2 we describe our method to represent and calculate powers of subgroup elements. In Section 3 we explain how a proper subgroup generator can conveniently be found using the method from Section 2. Cryptographic applications are given in Section 4, along with comparisons with RSA and ECC. In Section 5 we prove that the security of our method is equivalent to the security offered by traditional subgroup approaches. Extensions of our method are discussed in Section 6.

### 2. SUBGROUP REPRESENTATION AND ARITHMETIC

### 2.1 System Setup

Let p≡2 mod 3 be a prime number such that 6*log₂(p)≈1024 and such that φ₆(p)=p²−p+1 has a prime factor q with log₂(q)≧160. Such p and q (or of any other reasonable desired size) can quickly be found by picking a prime q≡7 mod 12, by finding the two roots r₁ and r₂ of x²−x+1≡0 mod q, and by finding an integer k such that rᵢ+k*q is 2 mod 3 and prime for i=1 or 2. If desired, primes q can be selected until the smallest or the largest root is prime, or any other straightforward variant that fits one's needs may be used, for instance to get log₂(q)≈180 and 6*log₂(p)≈3000, i.e., log₂(p) considerably bigger than log₂(q). From q≡7 mod 12 it follows that q≡1 mod 3 so that, with quadratic reciprocity, x²−x+1≡0 mod q has two roots. It also follows that q≡3 mod 4 which implies that those roots can be found using a single ((q+1)/4)^{th} powering modulo q.

By g ε GF(p⁶) we denote an element of order q. It is well known that g is not contained in any proper subfield of GF(p⁶) (cf. [4]). In the next section it is shown that there no need for an actual representation of g and that arithmetic on elements of GF(p⁶) can be entirely avoided. Thus, there is no need to represent elements of GF(p⁶), for instance by constructing an irreducible 3^{rd} degree polynomial over GF(p²). A representation of GF(p²) is needed however. This is done as follows.

From p≡2 mod 3 it follows that p mod 3 generates GF(3)*, so that the zeros α and α^{p} of the polynomial (X³−1) /(X−1)=X²+X+1 form an optimal normal basis for GF(p²) over GF(p). Because αⁱ=α^{imod3}, an element x ε GF(p²) can be represented as x₀α+x₁α^{p}=x₀α+x₁α² for x₀, x₁ ε GF(p), so that x^{p}=x₀^{p}α^{p}+x₁^{p}α^{2p}=x₁α+x₀α².

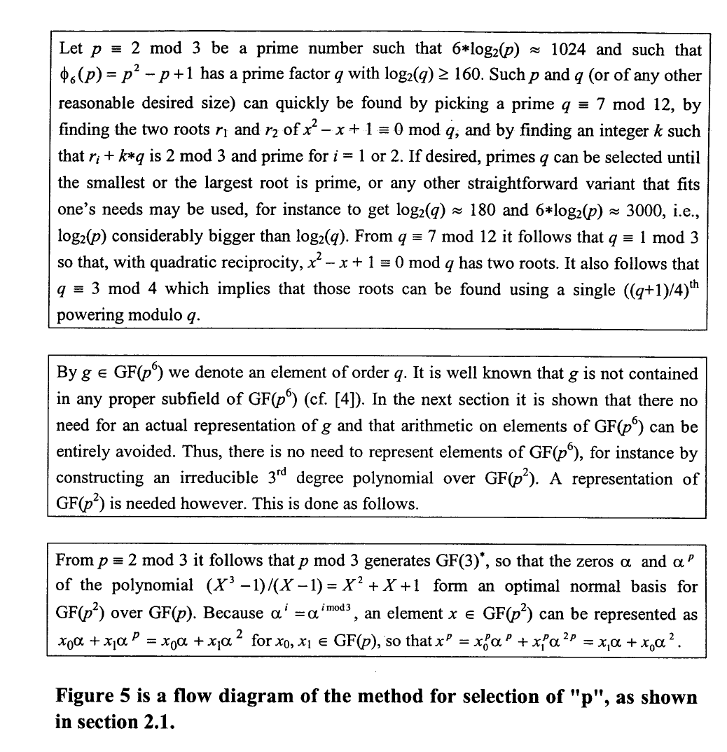

FIG. 5 is a flow diagram of the method for selection of “p”, as shown in section 2.1.

### 2.2 Cost of Arithmetic in GF(p²)

It follows from the last identity that p^{th} powering is for free in GF(p²). A squaring in GF(p²) can be carried out at the cost of 2 squarings and a single multiplication in GF(p), where as customary we do not count additions in GF(p). Straightforward multiplication in GF(p²) takes four multiplications in GF(p), but this can trivially be reduced to three by using a simple Karatsuba-like approach (cf. [5, section 4.3.3]): to compute (x₀α+x₁α²)*(y₀α+y₁α²) it suffices to compute x₀*y₀, x₁*y₁, and (x₀+x₁)*(y₀+y₁), after which x₀*y₁+x₁*y₀ follows using two subtractions.

### 2.3 Compact Representation of Powers of g and Their Conjugates

We present a number of straightforward results that show that powers of g, up to conjugacy, can be represented using a single element of GF(p²).

We recall the definition of the trace function Tr(x) from GF(p⁶) onto GF(p²) mapping x to x+x^{p}^{²}+x^{p}^{⁴}. Because the order of x ε GF(p⁶)* divides p⁶−1 the function is well defined. For x, y ε GF(p⁶) and c ε GF(p²), Tr(x+y)=Tr(x)+Tr(y) and Tr(cx)=c*Tr(x). That is, Tr(x) is GF(p²)-linear.

Lemma 2.3.1. The minimal polynomial of g over GF(p²) is X³−BX²+B^{p}X−1 ε GF(p²)[X] with B=g+g^{p-1}+g^{-p} ε GF(p²).

Proof. Because g is not contained in any proper subfield of GF(p⁶) it is a root of a unique monic irreducible polynomial F(X)=X³−BX²+CX−D ε GF(p²)[X]. Because F(X)^{p}^{²}=F(X^{p}^{²}) the roots of F(X) are g and its conjugates g^{p}^{²} and g^{p}^{⁴}. Because the order q of g divides p²−p+1 and because p²≡p−1 mod (p²−p+1) and p⁴≡−p mod (p²−p+1), we find that g^{p}^{²}=g^{p-1} and g^{p}^{⁴}=g^{-p} so that
D=g*g^{p}^{²}*g^{p}^{⁴}=g*g^{p-1}*g^{-p}=g^{1+p-1-p}=1
and
B=g+g^{p}^{²}+g^{p}^{⁴}=g+g^{p-1}+g^{-p}.

Note that B=Tr(g). From F(g^{-p})=0 it follows that
g^{-3p}−Bg^{-2p}+Cg^{-p}−1=g^{-3p}(1−Bg^{p}+Cg^{2p}−g^{3p})=g^{-3p}(1−B^{1/p}g+C^{1/p}g²−g³)^{p}=0.

Because F(X) is the unique monic irreducible polynomial in GF(p²)[X] that has g as a root it follows that B=C^{1/p}, i.e., C=B^{p}, which finishes the proof.

Remark 2.3.2. The identity C=B^{p} in the proof of Lemma 2.3.1 also follows from
C=g*g^{p-1}+g*g^{-p}+g^{p-1}*g^{-p}=g^{p}+g^{1-p}+g⁻¹
and
B^{p}=(g+g^{p-1}+g^{-p})^{p}=g^{p}+g⁻¹+g^{1-p}
since p²−p≡−1 mod (p²−p+1) and −p²≡1−p mod (p²−p+1).

Based on Lemma 2.3.1 it is tempting to represent g and its conjugates by Tr(g). We show that a result similar to Lemma 2.3.1 holds for any power of g and its conjugates. Consequently, gⁿ and its conjugates can be represented by Tr(gⁿ). For notational convenience we use the following definition.

Definition 2.3.3. Let T(n)=Tr(gⁿ) ε GF(p²). Note that T(n)=gⁿ+g^{np-n}+g^{-np} and that T(1)=B with B as in Lemma 2.3.1.

Lemma 2.3.4. T(np)=T(n)^{p}=g⁻ⁿ+g^{n-np}+g^{np}=T(−n).

Proof. Immediate from the definition of T(n) and from
g^{np}+g^{np}^{²}^{-np}+g^{-np}^{²}=g⁻ⁿ+g^{n-np}+g^{np}=T(−n)
as in Remark 2.3.2.

Lemma 2.3.5. For any integer n the roots of the polynomial X³−T(n)X²+T(n)^{p}X−1 ε GF(p²)[X] are gⁿ and its conjugates g^{np}^{²}=g^{np-n} and g^{np}^{⁴}=g^{-np}.

Proof. We compare the coefficients with the coefficients of the polynomial (X−g)(X−g^{np-n})(X−g^{-np}) The coefficient of X² follows from Definition 2.3.3, the constant coefficient from g^{n+np-n-np}32 1, and the coefficient of X from
g^{n+np-n}+g^{n-np}+g^{np-n-np}=g^{np}+g^{n-np}+g⁻ⁿ
and Lemma 2.3.4.

### 2.4 Computing T(n) for Arbitrary n

We show that T(n) can efficiently be computed for any nonnegative integer n.

Lemma 2.4.1. T(u+v)=T(u)*T(v)−T(v)^{p}*T(u−v)+T(u−2v).

Proof. Immediate from the definition of T(u) and T(v)^{p}=T(−v) (cf. Lemma 2.3.4).

Corollary 2.4.2. Let B=T(1) as in Lemma 2.3.1.
i. T(2n)=T(n)²−2T(n)^{p};
ii. T(n+1)=B*T(n)−B^{p}*T(n−1)+T(n−2);
iii. T(2n−1)=T(n)*T(n−1)−B*T(n−1)^{p}+T(n−2)^{p}.
iv. T(2n−3)=T(n−2)*T(n−1)−B^{p}*T(n)^{p}.

Proof.
i. This follows from Lemma 2.4.1 with u=v=n, T(0)=3, and Lemma 2.3.4: T(2n)=T(n)²−T(n)^{p}*T(0)+T(−n)=T(n)²−3T(n)^{p}+T(n)^{p}=T(n)²−2T(n)^{p}.
ii. This follows from Lemma 2.4.1 with u=n and v=1.
iii. This follows from Lemma 2.4.1 with u=n, v=n−1 and Lemma 2.3.4.
iv. This follows from Lemma 2.4.1 with u=n−2, v=n−1 and Lemma 2.3.4.

Definition 2.4.3. Let S(n)=(T(n−2), T(n−1), T(n)) for n>0, where T(−1)=T(1)^{p}=B^{p} (cf. Lemma 2.3.4) and T(0)=3.

Algorithm 2.4.4 for the, computation of T(n) given B=T(1). Given B (and B^{p}), we show how S(n+1) and S(2n) can be computed based on S(n). Computation of T(n) for arbitrary n then follows using the ordinary square and multiply method based on S(1)=(B^{p}, 3, B) (cf. Definition 2.4.3).
S(n+1) can be computed from S(n) using Corollary 2.4.2.ii. This takes two multiplications in GF(p²).
S(2n) can be computed by first using Corollary 2.4.2.i to compute T(2n−2) and T(2n) given S(n), at the cost of two squarings in GF(p²), followed by an application of Corollary 2.4.2.iii to compute T(2n−1) at the cost of two multiplications in GF(p²).

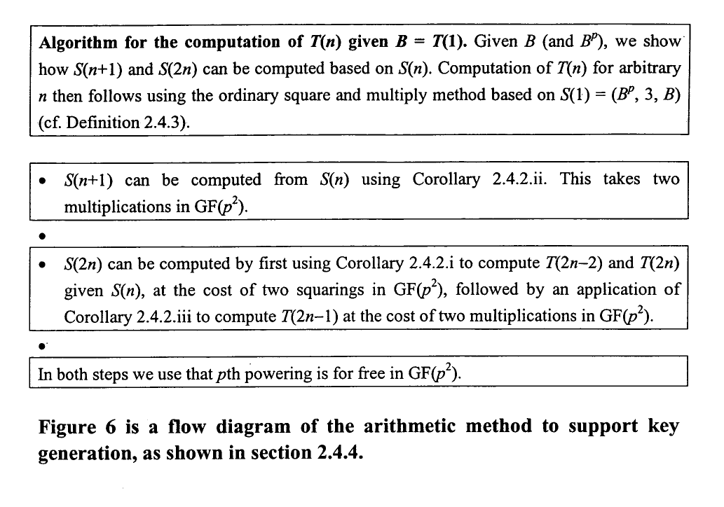

In both steps we use that pth powering is for free in GF(p²). FIG. 6 is a flow diagram of the arithmetic method to support key generation, as shown in section 2.4.4.

Theorem 2.4.5. Let w(n) denote the number of ones in the binary expansion of n. The representation T(n) of the nth power of g and its conjugates can be computed at the cost of 2*log₂(n) squarings in GF(p² ) and 2*w(n)+2*log₂(n) multiplications in GF(p²).

Proof. Immediate from Algorithm 2.4.4.

Corollary 2.4.6. With w(n) as in Theorem 2.4.5, the representation T(n) of the nth power of g and its conjugates can be computed at the cost of 4*log₂(n) squarings and 6*w(n)+8*log₂(n) multiplications in GF(p).

Proof. Immediate from Theorem 2.4.5 and 2.2.

Remark 2.4.7. Assuming that w(n)≈(log₂(n)/2) and that a squaring in GF(p) takes 80% of the time of a multiplication in GF(p), we find that the computation of T(n) for n≈q can be performed at an expected cost of about 14.2*log₂(q) multiplications in GF(p). This is more than 60% faster than the 37.8*log₂(q) multiplications in GF(p) required by the method from [4] where powers of g are more traditionally represented as elements of GF(p⁶) and which is substantially faster than standard methods to deal with subgroups. For the last estimate we assume that log₂(q)≈log₂(p). If elements of <g> are represented using a 3^{rd} degree extension of GF(p²), then exponentiation would take 42.3*log₂(q) multiplications in GF(p), due to the fact that arithmetic in GF(p²) is fast and because an extension polynomial of the special form X³−BX²+B^{p}X−1 may be used. Note that, unlike the methods from for instance [1], we do not assume that p has a special form. Using such primes leads to additional savings by making the arithmetic in GF(p) faster.

Corollary 2.4.2.iv allows us to replace the standard square and multiply method by the less well known binary method, thereby saving some multiplications.

Algorithm 2.4.8 for the computation of T(n) given B=T(1). Given B and S(n) it is straightforward to compute S(2n) or S(2n−1) using Corollary 2.4.2:
S(2n) is computed as in Algorithm 2.4.4 at the cost of two squarings and two multiplications in GF(p²).
S(2n−1) is computed by computing T(2n−1) and T(2n−2) as above at the cost of one squaring and two multiplications in GF(p²), and by computing T(2n−3) using Corollary 2.4.2.iv at the cost of two multiplications in GF(p²).

In both steps we use that pth powering is for free in GF(p²).

Let n>2 be some odd positive integer. To compute T(n) we proceed as follows. Let S(2)=(3, B, B²−2B^{p}) (cf. Definition 2.4.3 and Corollary 2.4.2.i), let r be such that 2^{r}<n<2^{r+1}, let 2^{r+1}−n=Σ_{0≦i<r}nᵢ2ⁱ with nᵢ ε {0,1}, and let k=2. For i=r−1, r−2, . . . , 0 in succession replace S(k) by S(2k) and k by 2k if nᵢ=0 and S(k) by S(2k−1) and k by 2k−1 if nᵢ=1. As a result we have that k=n so that T(n) follows from S(n).

If n is even we apply the above procedure to the odd part of n followed by one or more applications of Corollary 2.4.2.i.

Theorem 2.4.9. For a randomly selected N-bit number n, the representation T(n) of the nth power of g and its conjugates can be computed at an expected cost of 1.5*N squarings and 3*N multiplications in GF(p²).

Proof. Immediate from Algorithm 2.4.8.

Corollary 2.4.10. For a randomly selected N-bit number n, the representation T(n) of the nth power of g and its conjugates can be computed at an expected cost of 3 *N squarings and 9.5*N multiplications in GF(p).

Proof. Application of Theorem 2.4.9 and 2.2 leads to 3*N squarings and 10.5*N multiplications in GF(p). In the computation of S(2n−1), however, we compute both B*T(n−1)^{p} and B^{p}*T(n−1)^{p}, which can be done using 4 as opposed to 6 multiplications in GF(p) if we combine the computations. So we may expect to be able to save a total of (2*N)/2 multiplications in GF(p).

Remark 2.4.11. We find that the computation of T(n) for n≈q can be performed at an expected cost of about 11.9*log₂(q) multiplications in GF(p) (cf. assumptions in Remark 2.4.7). Thus, Algorithm 2.4.8 can be expected to be more than 15% faster than Algorithm 2.4.4. Under the assumption that log₂(q)≈log₂(p), exponentiation using Algorithm 2.4.8 is more than 3 times faster than the fast method from [4] mentioned in 2.4.7.

### 2.5 Computing Powers of Products

Efficient representation and computation of powers of g suffices for the implementation of many cryptographic protocols. Sometimes, however, the product of two powers of g must be computed. For the standard representations this is straightforward, but in our representation computing products is relatively complicated. Here we sketch how the problem of computing the product of two powers of g may be solved. Our description is geared towards cryptographic applications, but can easily be generalized. Let B represent a generator g of a subgroup of order q dividing p²−p+1, as in Lemma 2.3.1. Let y=g^{k} for a secret integer k (the private key), and let C=y+y^{p-1}+y^{-p} be y's representation. Obviously, the owner of the private key k can easily arrange the computation of C such that the representations C₊ of g*y=g^{k+1} and C₋ of y/g=g^{k-1} are computed as well. We show that if B, C, C₊, and C₋ are known, then for any pair of integers a, b the representation of g^{a}*y^{b} and its conjugates can be computed efficiently.

Lemma 2.5.1. Let T(m) be the representation of g^{m} and its conjugates, and let A be the following 3×3dimensional matrix over GF(p²):

$$A = ( \begin{matrix}B & - {B}^{p} & 1 \\ 1 & 0 & 0 \\ 0 & 1 & 0\end{matrix} ) .$$

Then

$$( \begin{matrix}T ( n + 1 ) \\ T ( n ) \\ T ( n - 1 )\end{matrix} ) = {A}^{n} * ( \begin{matrix}T ( 1 ) \\ T ( 0 ) \\ T ( - 1 )\end{matrix} ) ,$$

where T(1)=B, T(0)=3, and T(−1)=B^{p} (cf. 2.3.3 and 2.3.4).

Proof. From the definition of A and T(n+1)=B*T(n)−B^{p}*T(n−1)+T(n−2) (cf. Corollary 2.4.2.ii) it follows that

$$( \begin{matrix}T ( n + 1 ) \\ T ( n ) \\ T ( n - 1 )\end{matrix} ) = A * ( \begin{matrix}T ( 1 ) \\ T ( n - 1 ) \\ T ( n - 2 )\end{matrix} ) .$$

The proof follows by induction.

Thus, if for the representations T(u) and T(v) of g^{u} and g^{v} the uth and vth powers of A are known, then the representation T(u+v) of g^{u+v} can simply be computed by applying Lemma 2.5.1 with n=u+v to A^{u+v}=A^{u}* A^{v}. We show how A^{u} can be obtained from T(u), if T(u+1) and T(u−1) are known as well.

Lemma 2.5.2. Given T(0), T(1), T(−1), T(n), T(n+1), and T(n−1) the matrix Aⁿ can be computed as

$${A}^{n} = ( \begin{matrix}T ( n ) & T ( n + 1 ) & T ( n + 2 ) \\ T ( n - 1 ) & T ( n ) & T ( n + 1 ) \\ T ( n - 2 ) & T ( n - 1 ) & T ( n )\end{matrix} ) {( \begin{matrix}T ( 0 ) & T ( 1 ) & T ( 2 ) \\ T ( - 1 ) & T ( 0 ) & T ( 1 ) \\ T ( - 2 ) & T ( - 1 ) & T ( 0 )\end{matrix} )}^{- 1}$$

in a small constant number of operations in GF(p²).

Proof. Given T(0), T(1), T(−1), T(n), T(n+1), and T(n−1), Corollary 2.4.2.ii is used to compute T(±2) and T(n±2). As in the proof of Lemma 2.5.1 it follows that

$$( \begin{matrix}T ( n ) & T ( n + 1 ) & T ( n + 2 ) \\ T ( n - 1 ) & T ( n ) & T ( n + 1 ) \\ T ( n - 2 ) & T ( n - 1 ) & T ( n )\end{matrix} ) = {A}^{n} * ( \begin{matrix}T ( 0 ) & T ( 1 ) & T ( 2 ) \\ T ( - 1 ) & T ( 0 ) & T ( 1 ) \\ T ( - 2 ) & T ( - 1 ) & T ( 0 )\end{matrix} ) .$$

The proof follows by observing that

$$( \begin{matrix}T ( - 2 ) & T ( - 1 ) & T ( 0 ) \\ T ( - 1 ) & T ( 0 ) & T ( 1 ) \\ T ( 0 ) & T ( 1 ) & T ( 2 )\end{matrix} )$$

is the product of the Vandermonde matrix

$$( \begin{matrix}{g}^{- 1} & {g}^{- {p}^{2}} & {g}^{- {p}^{4}} \\ 1 & 1 & 1 \\ g & {g}^{{p}^{2}} & {g}^{{p}^{4}}\end{matrix} )$$

and its transpose, and therefore invertible. The determinant of the latter matrix equals T(p+1)^{p}−T(p+1), and (T(p+1)^{p}−T(p+1))²=B^{2p+p}+18*B^{p+1}−4*(B^{3p}+B³)−27 ε GF(p). Because p^{th} powering is for free in GF(p²), the proof follows.

Algorithm 2.5.3 for the computation of the representation of g^{a}*y^{b} for integers a, b with 1<a, b<q, given the representation B of g and the representations C, C₊, and C₋ of y, y*g, and y/g, respectively.
1. Compute c=a/b mod q;
2. Given B use Algorithm 2.4.8 to compute T(c+1), T(c), T(c−1) (note that the final applications of Corollary 2.4.2.i in Algorithm 2.4.8, if any, should be replaced by the usual calculation of the full S(2n));
3. Use Lemma 2.5.2 with T(0)=3, T(1)=B^{p}, T(−1)=B^{p}, T(c), T(c+1), and T(c−1) to compute A^{c};
4. Use Lemma 2.5.2 with T(0)=3, T(1)=B, T(−1)=B^{p}, T(k)=C, T(c+1)=C₃₀ , and T(c−1)=C₋ to compute the corresponding power of A, which we denote by A^{k}, even though k is unknown;
5. Compute A^{c+k};
6. Using Lemma 2.5.1 and A^{c+k} compute T(c+k);
7. Use Algorithm 2.4.8 with B replaced by T(c+k) and n replaced by b to compute the representation T((c+k)*b)=T(a+k*b) of g^{a}* y^{b}.

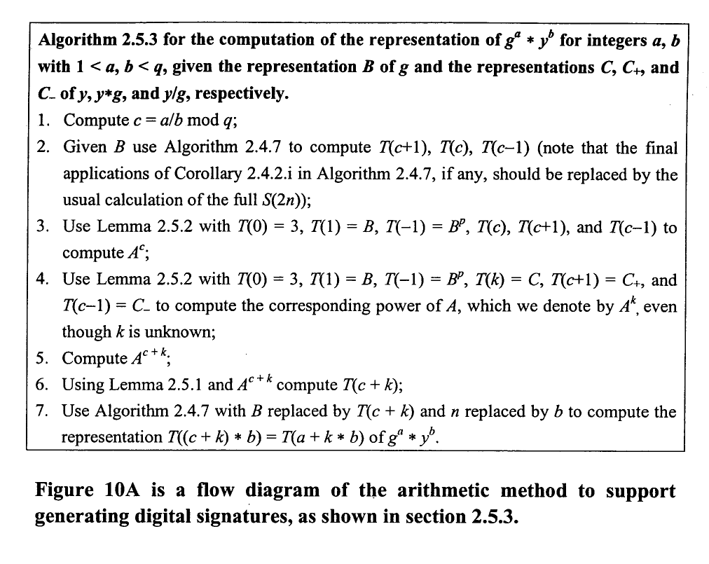

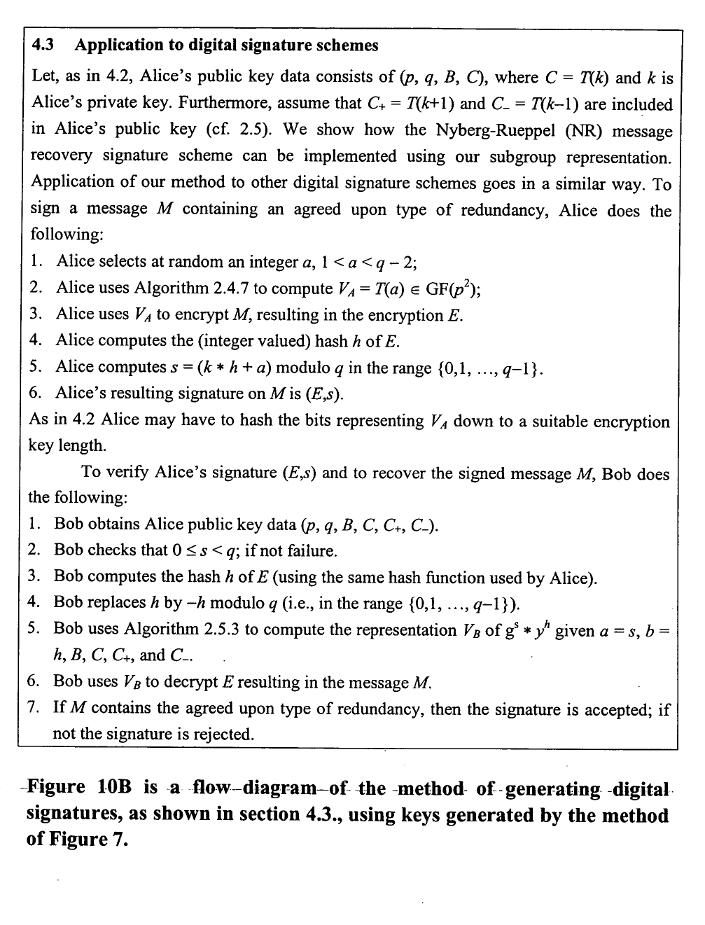

FIG. 10A is a flow diagram of the arithmetic method to support generating digital signatures, as shown in section 2.5.3.

Theorem 2.5.4. For randomly selected N-bit numbers a and b, the representation of g^{a}*y^{b} and its conjugates can be computed at an expected cost of 3*N squarings and 6*N multiplications in GF(p²) plus a small constant number of 3×3 matrix multiplications over GF(p²).

Proof. Immediate from Algorithm 2.5.3 and Theorem 2.4.9.

Corollary 2.5.5. For randomly selected N-bit numbers a and b, the representation of g^{a}*y^{b} and its conjugates can be computed at an expected cost of 6*N squarings and 19*N multiplications in GF(p) plus a small constant number of 3×3 matrix multiplications over GF(p²).

Proof. Immediate from Algorithm 2.5.3, Corollary 2.4.10, and 2.2.

Remark 2.5.6. Under the second assumption made in Remark 2.4.7, we find that the computation of the representation of g^{a}*y^{b} for a≈b≈q can be performed at an expected cost of about 23.8*log₂(q) multiplications in GF(p). If the more traditional but fast method from [4] is used to represent GF(p⁶), then computation of the representation of g^{a}*y^{b} takes almost 47*log₂(q) multiplications in GF(p). If elements of <g> are represented using a 3^{rd} degree extension of GF(p²) (cf. Remark 2.4.7), then the computation of the representation of g^{a}*y^{b} takes about 51*log₂(q) multiplications in GF(p). We conclude that both single and double exponentiations can be done much faster using our representation than using previously published techniques.

### 3. FAST INITIALIZATION

We describe three different ways to compute a proper initial B as in Lemma 2.3.1, i.e., an element B of GF(p²) such that there is a g ε GF(p⁶) of order q dividing p²−p+1 with B=g+g^{p-1}+g^{-p}.

### 3.1 Straightforward Approach

Algorithm 3.1.1 for the Computation of B.

1. Pick at random a third degree monic irreducible polynomial over GF(p²), and use that polynomial for representation of and arithmetic on elements of GF(p⁶).

2. Pick at random an element h ε GF(p⁶)*;

3. Compute the ((p⁶−1)/q)th power g of h;

4. If g=1, then return to Step 2;

5. Compute B=g+g^{p-1}+g^{-p}.

Theorem 3.1.2. Algorithm 3.1.1 can be expected to require 3 irreducibility tests over GF(p²) of third degree monic polynomials in GF(p²)[X], and 1−1/q exponentiations in GF(p⁶)* with exponent (p⁶−1)/q.

Proof. Immediate from the well known fact that a random monic third degree polynomial in GF(p²)[X] is irreducible with probability ⅓.

Although conceptually easy, Algorithm 3.1.1 requires actual representation of and manipulation with elements of GF(p⁶). From an implementation point of view it is therefore less attractive. Note that a random third degree polynomial H(X) in GF(p²)[X] can be tested for irreducibility by testing if gcd(X^{p}^{²}−X, H(X))=1 in GF(p²)[X]. This requires about 2*log₂(p) squarings and log₂(p) multiplications of elements of GF(p²)[X]/(H(X)), which can be carried out in 12*log₂(p) squarings and 69*log₂(p) multiplications in GF(p).

### 3.2 Randomized Approach Using Irreducibility

Algorithm 3.2.1 for the computation of B.

1. Pick at random an element B′ ε GF(p²)*\GF(p)*;

2. If X³−B′X²+B′^{p} X−1 ε GF(p²)[X] is reducible, then return to Step 1;

3. Use Algorithm 2.4.8 with B replaced by B′ to compute T((p²−p+1)/q) (i.e., with B′=T(1));

4. If T((p²−p+1)/q)=3, then return to Step 1;

5. Let B=T((p²−p+1)/q).

To justify Algorithm 3.2.1 we use the following two lemmas.

Lemma 3.2.2. An irreducible polynomial of the form X³−B′X²+B′^{p} X−1 ε GF(p²)[X] is the minimal polynomial of an element of GF(p⁶) of order >3 and dividing p²−p+1.

Lemma 3.2.3. For a randomly selected B′ ε GF(p²)*\GF(p)* the probability that the polynomial X³−B′X²+B′^{p}X−1 ε GF(p²)[X] is irreducible is about one third.

Lemma 3.2.2 proves that it makes sense to apply Algorithm 2.4.8 with B replaced by B′, because the role of g in Section 2 is played by some (unknown) element of GF(p⁶) of order dividing p²−p+1. This works because g never explicitly occurs in the computations in Algorithm 2.4.8 (except to compute B, which is replaced by B′ for our current purposes).

Lemma 3.2.3 proves that on average only about three different values for B′ have to be selected before an irreducible polynomial is found. The proof of the following theorem is immediate.

Theorem 3.2.4. Algorithm 3.2.1 can be expected to require 3*(1−1/q) irreducibility tests over GF(p²) of third degree monic polynomials of the form X³−B′X²+B′^{p}X−1 in GF(p²)[X], and 1−1/q applications of Algorithm 2.4.8 with n=(p²−p+1)/q.

Proof of Lemma 3.2.2. Because X³−B′X²+B′^{p}X−1 ε GF(p²)[X] is irreducible its roots are in GF(p⁶)*\GF(p²)* and thus of order dividing (p⁶−1)/(p²−1)=p⁴+p²1. Denote the roots by h and its conjugates h^{p}^{²} and h^{p}^{⁴}=h^{-p}^{²}⁻¹, the latter because the order of h divides p⁴+p²+1. If h³=1, then h^{p}^{²} would be equal to h since p=2 mod 3, and h would be in GF(p²) contradicting the irreducibility. Because the order of h cannot be even, it follows that the order of h is >3. Reversing the argument in the proof of Lemma 2.3.1 it follows that if h is a root, then so is h^{-p}. Thus either h=h^{-p}, or h^{p}^{²}=h^{-p}, or h^{-p}^{²}⁻¹=h^{31 p}. The first two possibilities are in contradiction with the fact that the order of h divides p⁴+p²+1, that gcd(p⁴+p²+1,p+1)=3, and that the order of h is >3, and the last remaining possibility leads to the conclusion that the order of h divides p²−p+1.

Proof of Lemma 3.2.3. This follows from a straightforward counting argument. About p²−p elements of the subgroup of order p²−p+1 of GF(p⁶)* are roots of monic irreducible polynomials of the form X³−B′X²+B′^{p}X−1 ε GF(p²)[X] (cf. Lemma 2.3.1). Since each of these polynomials has three distinct roots, there must be about (p²−p)/3 different values for B′ in GF(p²)*\GF(p)* such that X³−B′X²+B′^{p}X−1 is irreducible.

Compared to Algorithm 3.1.1, the arithmetic in GF(p⁶) is replaced in Algorithm 3.2.1 by application of Algorithm 2.4.8. That is much more convenient for the implementation of our method, because Algorithm 2.4.8 is required anyhow. We now show that the irreducibility tests can be replaced by an application of Algorithm 2.4.8 as well.

### 3.3 Randomized Approach Without Irreducibility

If B′ as in Step 1 of Algorithm 3.2.1 leads to an irreducible polynomial in Step 2, then we know that T(n) corresponds to the sum of the conjugates of the nth powers of an element of order dividing p²−p+1 and we know how to compute T(n) efficiently based on B′. We now consider what we can say about a thus computed T(n) if the polynomial in Step 2 of Algorithm 3.2.1 is not known to be irreducible. This leads to results that are very similar to those of Section 2, but the proofs are slightly more cumbersome. Let B′ be an element of GF(p²) and let α, β, and γ be the, not necessarily distinct, roots of F(X)=X³−B′X²+B′^{p}X−1 ε GF(p²)[X].

Lemma 3.3.1.

i. B′=α+β+γ;

ii. α*β*γ=1;

iii. αⁿ*βⁿ+αⁿ*γⁿ+βⁿ*γⁿ=γ⁻ⁿ+β⁻ⁿ+α⁻ⁿ for any integer n.

Proof. Immediate. Note that iii uses ii.

If F(X) is irreducible, then it follows from Lemma 3.2.2 that α, β, and γ are of the form g, g^{p-1}, g^{-p} for some g in GF(p⁶) of order >3 and dividing p²−p+1. If F(X) is reducible, we have the following lemma.

Lemma 3.3.2. If F(X) is reducible, then α, β, γ rare in GF(p²).

Proof. Using the same argument as in the proof of Lemma 3.2.2 we find that α^{-p}, β^{-p}, and γ^{-p} are also roots of F(X). Without loss of generality, we find that either α=α^{-p}, β=β^{-p}, γ=γ^{-p}, or α=α^{-p}, γ=β^{-p}, β=γ^{-p}, or β=α^{-p}, γ=β^{-p}, α=γ^{-p}. In the first case all roots have order divisible by p+1, so that they are all in GF(p²). In the second case α has order divisible by p+1 and β and γ have order divisible by p²−1, so that they are again all in GF(p²). In the final case it follows that 1=α*β*γ=α*α^{-p}*α^{p}^{²}=α^{1-p+p}^{²}=β^{1-p+p}^{²}=γ^{1-p+p}^{²}. Because F(X) is reducible, at least one root, say α, is in GF(p²), so that the order of α divides gcd(p²−p+1,p²+1)=3 (since p=2 mod 3). But from α³=1, β=α^{-p}, and γ=β^{-p} it now follows that α=β=γ=α^{-p} so that the third case does not occur but is covered by the first case.

Definition 3.3.3. Let V(n)=αⁿβⁿ=γⁿ. Note that V(1)=B′ and that V(n) ε GF(p²) because V(n)=T(n) if F(X) is irreducible and α, β, γ GF(p²) otherwise.

Lemma 3.3.4. V(np)=V(n)^{p}=α⁻ⁿ+β⁻ⁿ+γ⁻ⁿ=V(−n).

Proof. From the proof of Lemma 3.3.2 it follows that α+β+γ=α^{-p}+β^{-p}+γ^{-p} and, more generally, that α^{m}+β^{m}+γ^{m}=α^{-mp}+β^{-mp}+γ^{-mp} for any integer m. The proof follows by taking m=−n.

Lemma 3.3.5. For any integer n the roots of the polynomial X³−V(n)X²+V(n)^{p}X−1 ε GF(p²)[X] are αⁿ, βⁿ, and γⁿ.

Proof. If F(X) is irreducible the result follows from Lemma 2.3.5, so let us assume that F(X) is reducible. As in the proof of Lemma 2.3.5 we compare the coefficients with the coefficients of the polynomial (X−αⁿ)(X−βⁿ)(X−γⁿ). The coefficient of X² follows from Definition 3.3.3, the constant coefficient from Lemma 3.3.1.ii, and the coefficient of X from Lemma 3.3.1.iii and Lemma 3.3.4.

It follows from Lemmas 2.3.5 and 3.3.5 that even if F(X) is reducible, V(n) and T(n) play very similar roles, because they can be used in the same way to define a polynomial that has the nth powers of the roots of F(X) as its roots. We now show that V(n) can be computed in the same way as T(n).

Lemma 3.3.6. V(u+v)=V(u)*V(v)−V(v)^{p}* V(u−v)+V(u−2v).

Proof. Immediate from the definition of V(u) and V(v)^{p}=V(−v) (cf. Lemma 3.3.4).

Algorithms 2.4.4 and 2.4.8 are based on Corollary 2.4.2, which is based on Lemma 2.4.1. Lemma 3.3.6 is the equivalent of Lemma 2.4.1 with T replaced by V. Therefore, V(n) can be computed using Algorithm 2.4.4 or Algorithm 2.4.8 with B replaced by B′ and T replaced by V.

Lemma 3.3.7. F(X) ε GF(p²)[X] is reducible if and only if V(p+1) ε GF(p).

Proof. If F(X) is reducible then α, β, γ ε GF(p²) (Lemma 3.3.2) so that α^{p+1}, β^{p+1}, γ^{p+1} ε GF(p) and thus V(p+1)=α^{p+1}+β^{p+1}+γ^{p+1} ε GF(p) ε GF(p), then V(p+1)^{p}=V(p+1), so that X³−V(p+1)X²+V(p+1)X−1 has 1 as a root. Because the roots of X³−V(p+1)X²+V(p+1)X−1 are the (p+1)st powers of the roots of F(X) (cf. Lemma 3.3.5), it follows that F(X) has a root of order dividing p+1, so that F(X) is reducible over GF(p²).

This leads to the following algorithm to find a proper initial B as in Lemma 2.3.1.

Algorithm 3.3.8 for the Computation of B.

1. Pick at random an element B′ ε GF(p²)*\GF(p)*;

2. Use Algorithm 2.4.8 with B replaced by B′ and T replaced by V to compute V(p+1) (i.e., with B′=T(1)=V(1));

3. If V(p+1) ε GF(p), then return to Step 1;

4. Use Algorithm 2.4.8 with B replaced by B′ to compute T((p²−p+1)/q) (i.e., with B′=T(1));

5. If T((p²−p+1)/q)=3, then return to Step 1;

6. Let B=T(p²−p+1)/q).

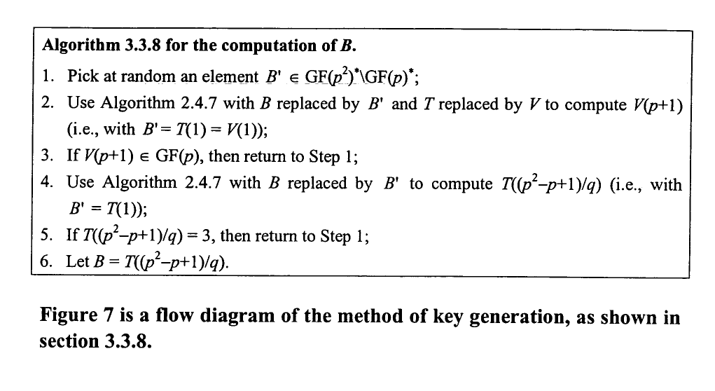

FIG. 7 is a flow diagram of the method of key generation, as shown in section 3.3.8.

Theorem 3.3.9. Algorithm 3.3.8 computes an element B ε GF(p²) such that B=g+g^{p-1}+g^{-p} for an element g of GF(p⁶) of order q>3 dividing p²−p+1. It can be expected to require 3*(1−1/q) applications of Algorithm 2.4.8 with n=p+1 and 1−1/q applications of Algorithm 2.4.8 with n=(p²−p+1)/q.

Proof. The correctness of Algorithm 3.3.8 follows from the fact that F(X) is irreducible if V(p+1) ∉ GF(p) (Lemma 3.3.7). The run time estimate follows from Lemma 3.2.3 and the fact that V(p+1) ∉ GF(p) if F(X) is irreducible (Lemma 3.3.7).

### 4. APPLICATIONS

The subgroup representation method described in Section 2 can be used in any cryptosystem that relies on the (subgroup) discrete logarithm problem. In this section we describe some of these applications in more detail. We assume that primes p and q have been selected as described in 2.1 such that q divides p²−p+1 and that B ε GF(p²) has been determined as representation of a generator of a subgroup of order q, for instance using the method described in Section 3. We also discuss how the public key data p, q, and B may be represented, and we compare the performance of our method with RSA and ECC.

### 4.1 Application to the Diffie-Hellman Scheme

Suppose that two parties, Alice and Bob, who both have access to the public key data p, q, B want to agree on a shared secret key. They can do this by performing the following variant of the Diffie-Hellman scheme:
1. Alice selects at random an integer a, 1<a<q−2, uses Algorithm 2.4.8 to compute V_{A}=T(a) ε GF(p²), and sends V_{A} to Bob.
2. Bob receives V_{A} from Alice, selects at random an integer b, 1<b<q−2, uses Algorithm 2.4.8 to compute V_{B}=T(b) ε GF(p²), and sends V_{B} to Alice.
3. Alice receives V_{B} from Bob, and uses Algorithm 2.4.8 with B replaced by V_{B} (i.e., with V_{B}=T(1)) to compute K_{AB}=T(a) ε GF(p²).
4. Bob uses Algorithm 2.4.8 with B replaced by V_{A} (i.e., with V_{A}=T(1)) to compute K_{AB}=T(b) ε GF(P²).

The length of the messages exchanged in this DH variant is about one third of the length of the messages in other implementations of the DH scheme that achieve the same level of security and that are based on the difficulty of computing discrete logarithms in (a subgroup of) the multiplicative group of a finite field. Also, our variant of the DH scheme requires considerable less computation than those previously published methods (cf. Remark 2.4.11).

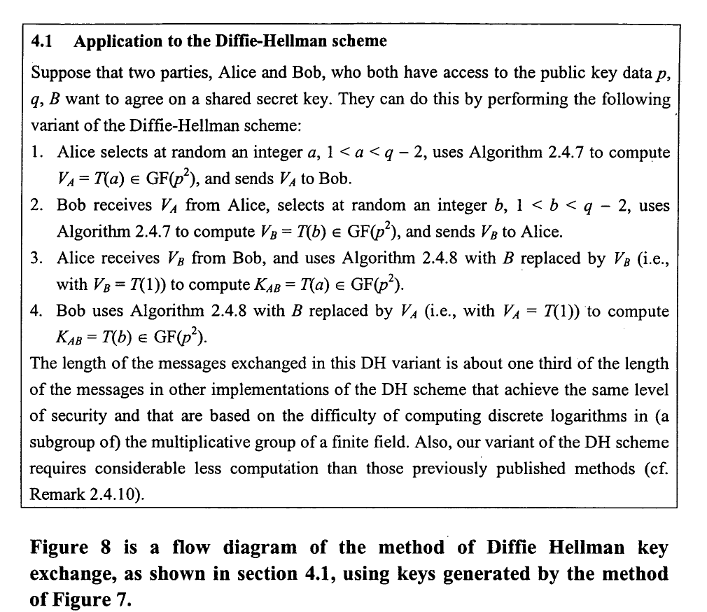

FIG. 8 is a flow diagram of the method of Diffie Hellman key exchange, as shown in section 4.1, using keys generated by the method of FIG. 7.

### 4.2 Application to the ElGamal Encryption Scheme

Suppose that Alice is the owner of the public key data p, q, B, and that Alice has selected a secret integer k and computed the corresponding public value C=T(k) using Algorithm 2.4.8. Thus, Alice's public key data consists of (p, q, B, C). Given Alice's public key (p, q, B, C) Bob can encrypt a message M intended for Alice using the following variant of ElGamal encryption:
1. Bob selects at random an integer b, 1<b<q−2;
2. Bob uses Algorithm 2.4.8 to compute V_{B}=T(b) ε GF(P²);
3. Bob uses Algorithm 2.4.8 with B replaced by C (i.e., with C=T(1)) to compute K=T(b) ε GF(p²);
4. Bob uses K to encrypt M, resulting in the encryption E.
5. Bob sends (V_{B},E) to Alice.

Note that Bob may have to hash the bits representing K down to a suitable encryption key length.

Upon receipt of (V_{B},E), Alice decrypts the message in the following manner:
1. Alice uses Algorithm 2.4.8 with B replaced by V_{B} (i.e., with V_{B}=T(1)) to compute K=T(k) ε GF(P²);
2. Alice uses K to decrypt E resulting in M.

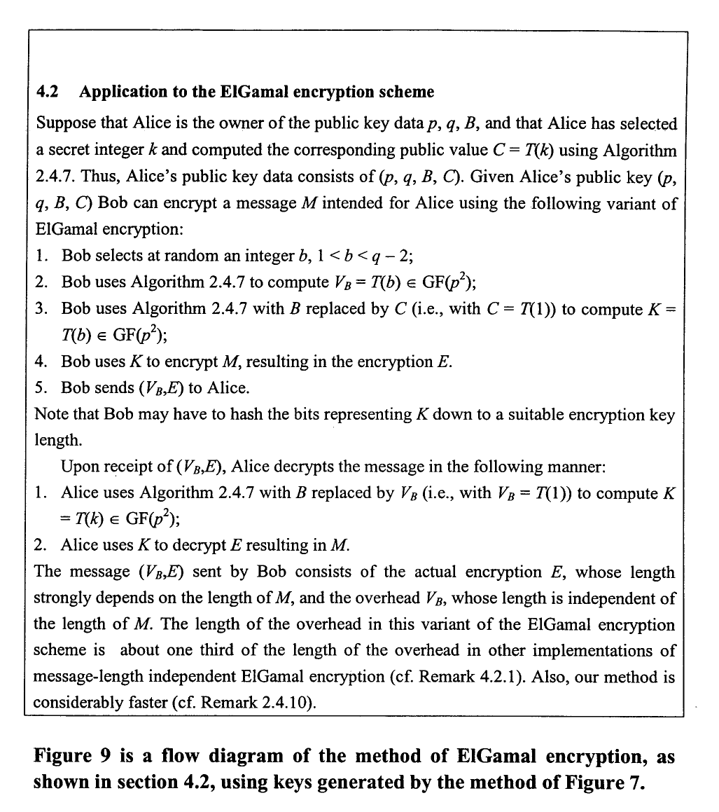

The message (V_{B},E) sent by Bob consists of the actual encryption E, whose length strongly depends on the length of M, and the overhead V_{B}, whose length is independent of the length of M. The length of the overhead in this variant of the ElGamal encryption scheme is about one third of the length of the overhead in other implementations of message-length independent ElGamal encryption (cf. Remark 4.2.1). Also, our method is considerably faster (cf. Remark 2.4.11). FIG. 9 is a flow diagram of the method of ElGamal encryption, as shown in section 4.2, using keys generated by the method of FIG. 7.

Remark 4.2.1. Our variant of ElGamal encryption is based on the common message-length independent version of ElGamal encryption, i.e., where the key K is used in conjunction with an (unspecified) symmetric key encryption method. In more traditional ElGamal encryption the message is restricted to the key space and ‘encrypted’ using, for instance, multiplication by the key, an invertible operation that takes place in the key space. In our description this would amount to requiring that M ε GF(p²), and by computing E as K*M ε GF(p²). Compared to this more traditional variant of ElGamal encryption we save a factor three on the length of both parts of the encrypted message, for messages that fit in our key space (of one third of the ‘traditional’ size).

### 4.3 Application to Digital Signature Schemes

Let, as in 4.2, Alice's public key data consists of p, q, B, C), where C=T(k) and k is Alice's private key. Furthermore, assume that C₊=T(k+1) and C₋=T(k−1) are included in Alice's public key (cf. 2.5). We show how the Nyberg-Rueppel (NR) message recovery signature scheme can be implemented using our subgroup representation. Application of our method to other digital signature schemes goes in a similar way. To sign a message M containing an agreed upon type of redundancy, Alice does the following:
1. Alice selects at random an integer a, 1<a<q−2;
2. Alice uses Algorithm 2.4.8 to compute V_{A}=T(a) ε GF(p²);
3. Alice uses V_{A} to encrypt M, resulting in the encryption E.
4. Alice computes the (integer valued) hash h of E.
5. Alice computes s=(k*h+a) modulo q in the range {0,1, . . . , q−1 }.
6. Alice's resulting signature on M is (E,s).

As in 4.2 Alice may have to hash the bits representing V_{A} down to a suitable encryption key length.

To verify Alice's signature (E,s) and to recover the signed message M, Bob does the following:
1. Bob obtains Alice public key data (p, q, B, C, C₊, C₋).
2. Bob checks that 0≦s<q; if not failure.
3. Bob computes the hash h of E (using the same hash function used by Alice).
4. Bob replaces h by −h modulo q (i.e., in the range {0,1, . . . , q−1.}).
5. Bob uses Algorithm 2.5.3 to compute the representation V_{B} of g^{s}*y^{h} given a=s, b=h, B, C, C₊, and C₃₁.
6. Bob uses V_{B} to decrypt E resulting in the message M.
7. If M contains the agreed upon type of redundancy, then the signature is accepted; if not the signature is rejected.

Both for signature generation and signature verification our method is considerably faster than other subgroup based implementations of the NR scheme (cf. Remarks 2.4.11 and 2.5.6. The length of the signature is identical to other variants of the NR scheme that are message-length independent (cf. Remark 4.2.1): an overhead part of length depending on the desired security (i.e, the subgroup size) and a message part of length depending on the message itself and the agreed upon redundancy. Similar statements hold for other digital signature schemes, such as DSA.

FIG. 10B is a flow diagram of the method of generating digital signatures, as shown in section 4.3., using keys generated by the method of FIG. 7.

### 4.4 Public Key Size

For the applications in 4.1 and 4.2 a public key consisting of p,q,B,C) suffices. For the digital signature application in 4.3 a much larger public key consisting of (p, q, B, C, C₊, C₋) is required. We assume that public keys are certified in some way, and that the certificates contain information identifying the owner of the key. Furthermore, we assume that the bit-lengths P of p and Q of q are fixed system parameters, known to all parties in the system, and that P>Q−2 (cf. 2.1). We discuss how much overhead is required for the representation of the public key in a certificate, i.e., on top of the user ID and other certification related bits.

If no attempts are made to compress the key, then representing (p,q,B,C) takes 5*P+Q bits, and (p, q, B, C, C₊, C₋) requires 9*P+Q bits. We sketch one possible way how, at the cost of a small computational overhead for the recipient of the public key, p, q, and B can be represented using far fewer than 3 *P+Q bits.

First of all, the prime q can be determined as a function ƒ of the user ID and a small seed s, for some function ƒ that is known to all parties in the system. The seed could consist of a random part s₁ and a small additive part s₂ that is computed by the party that determines q, for instance by finding a small integer s₂ (of about log₂(Q) bits) such that 12*(ƒ(ID,s₁)+s₂)+7 is prime (and defines q, cf 2.1). Given q, the smallest (or largest) root r in {0, 1, . . . , q−1} of x²−x+1 modulo q can be found using a single exponentiation in GF(q). From P an integer z₁ easily follows such that p should be at least r+z₁*q, and a small integer z₂ (of about log₂(P) bits) can be found such that r+z₁*q+z_{2*}q is prime (and defines p, cf. 2.1). Thus, assuming that ƒ, P, and Q are system-wide parameters, the primes q and p can be determined given the user ID, s, and z₂ at the cost of essentially a single exponentiation in GF(q). Alternatively, and if allowed by P, the party determining q may pick random s₁'s until r (or r+z₁*q) itself is prime (and defines p). In that case q and p are fully determined by and can quickly be recovered from the user ID and s.

To compress the number of bits required for the representation of B we assume that the party that determines B uses Algorithm 3.3.8, but instead of selecting B′ at random in Step 1 of Algorithm 3.3.8, tries B′=iα+(i+1)α² (cf. 2.1) for i=2,3,4, . . . , in succession, until Step 6 is reached. The final B′ can usually be represented using at most 5 bits (if not, just pick another s₁ and start all over again). The corresponding B can be determined given B′ at the cost of a single application of Algorithm 2.4.8 with B replaced by B′, as in Step 4 of Algorithm 3.3.8.

All these computations to recover p, q, and B can easily be performed by the recipient of a certificate. Correctness of the bits provided (i.e., if they lead to primes q and p of the right sizes, and to a B representing an order q element) should be verified by the certification authority. We conclude that p, q, and B can be selected in such a way that they can be recovered from the user ID and an additional log₂(s₁)+log₂(Q)+log₂(P)+5 bits. In practical situations 48 additional bits, i.e., 6 bytes, should be enough.

We conclude that for our versions of the DH scheme and ElGamal encryption the public key data overhead in the certificates can be limited to 48+2*P bits: 48 bits from which p, q, and B can be derived, and 2*P bits for C. For 170-bit subgroups and 1024-bit finite fields that is about one third of the size of traditional subgroup public keys. It is somewhat more than twice the size of an ECC public key, assuming the finite field, elliptic curve data, and group size are shared among all parties in the ECC system. If curves or finite fields are not shared, then ECC public keys need substantially more bits than our method when applied as in 4.1 or 4.2 unless similar ID based methods are used for curve and finite field generation (cf. 4.5).

The public key overhead of our method when used in conjunction with digital signatures, as in 4.3, is much larger, namely 48+6*P bits. This is still competitive with traditional subgroup public key sizes, but more than non-shared ECC public key sizes. In the next subsection we show how 2*P bits can be saved at the cost of a moderate one time computation for the recipient of the public key.

### 4.5 Reducing the Public Key Size for Digital Signature Applications

For digital signature applications of our method the public key contains C, C₊, and C₋. We show that, at the cost of a moderate one time computation for the recipient of the public key, it suffices to send just two of C, C₊, and C₋, thereby reducing the public key overhead for digital signature applications of our method from 48+6*P to approximately 48+4*P bits. An easy way to see this is as follows. Assume that C and C₊ are given. From Lemma 2.5.2 with T(0)=3, T(1)=B, T(n)=C and T(n+1)=C₊ and the fact that the determinant of the matrix A equals 1 it follows that T(n−1)=C₋ has to be determined such that the determinant of the matrix from Lemma 2.5.2 with T(n) on the diagonal equals the determinant of the matrix from Lemma 2.5.2 with T(0) on the diagonal. This leads to a third degree equation in T(n−1) (i.e., C₋) over GF(p²), which can be solved at the cost of a small number of pth powerings in GF(p²). The correct candidate can be determined at the cost of at most a few additional bits in the public key. We present a conceptually more complicated method that can be used not only to determine C₋, but that can also be used to establish the correctness of C₊ (i.e., that C₊ is the proper value corresponding to B and C). Let C=y+y^{p-1}+y^{-p}, as in 2.5.

Definition 4.5.1. Let Fᵣ ε GF(p²)[X] denote the minimal polynomial over GF(p²) of r ε GF(p⁶).

Definition 4.5.2. Let r, s ε GF(p⁶). The root-product [symbol] (r,s) of r and s is defined as the polynomial with roots {α*β|α, β ε GF(p⁶), Fᵣ(α)=0, Fₛ(β)=0}.

Lemma 4.5.3. Let r, s ε GF(p⁶). Then [symbol] (r,s)=Fᵣₛ*Fᵣₛ_{^{p}}_{²}*Fᵣₛ_{^{p}}_{⁴} ε GF(p²)[X].

Proof. According to Definition 4.5.2 the roots of the root-product [symbol] (r,s) are r^{p}^{ⁱ} s^{p}^{^{j}} for i, j ε {0,2,4}, i.e., rs and its conjugates over GF(p²) (for i=j), rs^{p}^{²} and its conjugates (for j≡i+2 mod 6), and rs^{p}^{⁴} and its conjugates (for j≡i+4 mod 6). The proof follows.

Lemma 4.5.4. Given B and T(p−2), values K, L, M ε GF(p²) such that g^{p}≡Kg²+Lg+M modulo g³−Bg²+B^{p}g−1 can be computed at the cost of a small constant number of operations in GF(p²).

Proof. By raising g^{p}≡Kg²+Lg+M to the (pⁱ)^{th} power for i=0, 2, 4, and by adding the three resulting identities, we find that T(p)=KT(2)+LT(1)+MT(0). Similarly, from g^{p-1} ≡Kg+L+Mg⁻¹ and g^{p-2}≡K+Lg⁻¹+Mg⁻² it follows that T(p−1)=KT(1)+LT(0)+MT(1) and T(p−2)=KT(0)+LT(−1)+MT(−2), respectively. With T(p−1)=T(p²)=T(1)=B and T(p)=T(1)¹=B^{p}, this leads to the following system of equations over GF(p²):

$$( \begin{matrix}T ( p - 2 ) \\ B \\ {B}^{p}\end{matrix} ) = ( \begin{matrix}T ( 0 ) & T ( 1 ) & T ( 2 ) \\ T ( - 1 ) & T ( 0 ) & T ( 1 ) \\ T ( - 2 ) & T ( - 1 ) & T ( 0 )\end{matrix} ) ( \begin{matrix}K \\ L \\ M\end{matrix} ) .$$

Because T(p−2) is given and the matrix on the right hand side is invertible (cf. proof of Lemma 2.5.2) the proof follows.

Lemma 4.5.5. Given B, C, and T(p−2), the root-product [symbol] (g, y) can be computed at the cost of a small constant number of operations in GF(p²).

Proof. Since C=y+y^{p-1}+y^{-p} we have that F_{y}(X)=X³−CX²+C^{p}X−1 ε GF(p²)[X]. For any z ε GF(p⁶) the roots of the polynomial z³*F_{y}(X/z) ε GF(p⁶)[X] are zy, zy^{p-1}, zy^{-p}. Thus, [symbol] (g,y) ε GF(p²)[X] can be written as the following product in GF(p⁶)[X]:
(g³*F_{y}(X*g⁻¹))*(g^{3(p-1)}*F_{y}(X*g^{-p+1}))*(g^{-3p}*F_{y}(X*g^{p}))=F_{y}(X*g⁻¹)*F_{y}(X*g^{-p+1})*F_{y}(X*g^{p}),
because the product of g and its conjugates equals 1. To compute [symbol] (g, y) we represent GF(p⁶) as GF(p²)[X]/F_{g}(X)=GF(p²)(g), i.e., by adjoining g with g³−Bg²+B^{p}g−1=0 to GF(p²). In this representation, F_{y}(X*g⁻⁹) can easily be computed. The remaining two factors F_{y}(X*g^{-p+1}) and F_{y}(X*g^{p}) can be computed given a representation of g^{p} in GF(p²)(g), i.e., K, L, M ε GF(p²) such that g^{p}=Kg²+Lg+M. With Lemma 4.5.4 the proof now follows.

Lemma 4.5.6. Given B, C, C₊, and T(p−2), the correctness of C₊ can be checked at the cost of a small constant number of operations in GF(p²).

Proof. Given B and C, the value for C₊ is correct if the roots in GF(p⁶) of the polynomial X³−C₊X²+C₊^{p}X−1 ε GF(p²)[X] are αβ and their conjugates, where α is a root of X³−BX²+B^{p}X−1 (i.e., α=g, g^{p-1}, or g^{-p}) and β is a root of X³−CX²+C^{p}X−1 (i.e., β=y, y^{p-1}, or y^{-p}). According to Lemma 4.5.3 the root-product [symbol] (g,y) ε GF(p²)[X] is the product of the three minimal polynomials of gy, gy^{p-1}, and gy^{-p}, respectively, so that C₊ is correct if and only if the polynomial X³−C₊X²+C₊^{p}X−1 ε GF(p²)[X] divides [symbol] (g,y). The proof now follows from Lemma 4.5.5.

Lemma 4.5.7. Given B, C, C₊, and T(p−2), the corresponding C₋ can be computed at the cost of a small constant number of operations in GF(p²).

Proof. Without loss of generality we assume that the roots of X³−C₊X²+C₊^{p}X−1 are gy and its conjugates. It follows from Lemma 4.5.3 that the corresponding C₋ satisfies X³−C₋X²+C₋^{p}X−1=gcd(z,900 (g⁻¹,y), z,900 (g⁻²,gy)). The proof now follows from the observation that the root-products [symbol] (g⁻¹,y) and z,900 (g⁻²,gy) can be computed as in the proof of Lemma 4.5.5 (with C replaced by C₊ for the computation of [symbol] (g⁻²,gy)).

Lemma 4.5.8. Given B, the value of T(p−2) can be computed at the cost of a squareroot computation in GF(p), assuming one bit of information to resolve the squareroot ambiguity.

Proof. It follows from Corollary 2.4.2.ii, T(p)=B^{p}, and T(p−1)=T(1)=B that T(p−2)=T(p+1). Let T(p+1)=x₁α+x₂α² with x₁, X₂ ε GF(p). Thus, −(s₁+x₂)=T(p+1)^{p}+T(p+1) (cf. 2.1). With T(p+1)=g^{p+1}+g^{p-2}+g^{-2p+1}, T(p+1)^{p}=g^{-p-1}+g^{-p+2}+g^{2p-1}, and B^{p+1}=B*B^{p}=(g+g^{p-1}+g^{-p})*(g^{p}′g⁻¹+g^{-p+1})=g^{p+1}+g^{p-2}+g^{-2p+1}+g^{-p-1}+g^{-p+2}+g^{2p-1}+3=T(p+1)^{p}+T(p+1)+3 it follows that x₁+X₂=3−B^{p+1} ε GF(p).

Similarly, it follows from straightforward evaluation that (T(p+1)^{p}−T(p+1))²=−3*(x₁−x₂)². With the identity for (T(p+1)^{p}−T(p+1))² given in the proof of Lemma 2.5.2 we find that −3*(x₁−x₂)²=B^{2p+2}+18*B^{p+1}−4*(B^{3p}+B³)−27 ε GF(p). The proof follows by using that x₁+x₂=3−B^{p+1}.

It follows from Lemma 4.5.7 that C₋ does not have to be included in the public key for digital signature applications. A single additional bit is required in the public key if Lemma 4.5.8 is used by the recipient of the public key to compute T(p−2). The expected cost of the computation of T(p−2) using Lemma 4.5.8 is 1.3*log₂(p) multiplications in GF(p) if we make the additional assumption that p≡3 mod 4. Without Lemma 4.5.8, and without the additional bit, the computation of T(p−2) takes an expected 11.9*log₂(p) multiplications in GF(p), according to 2.4.11. Note that also C₊ does in principle not have to be included in the public key, because the recipient can determine C₊ by factoring the ninth degree polynomial z,900 (g,y) ε GF(p²)[X] into three third degree irreducible polynomials in GF(p²)[X].

### 4.6 Comparison with RSA and ECC

We give a rough comparison of the performance of RSA, ECC, and our method, which we refer to as XTR. We assume that XTR with P=Q=170 (cf. 4.4) offers approximately the same security as 6*P-bit RSA with a 32-bit public exponent and as ECC with a randomly selected curve over a random P-bit prime field and with a Q-bit prime dividing the group order.

4.6.1. Public key sizes. For all systems the number of bits of the public keys depends on the way the public keys are generated, because in all cases considerable savings can be obtained by including the user ID in the generation process (cf. 4.4). For RSA the user ID may be included in the modulus (cf. [7]) and the public exponent may be fixed or determined as a function of the used ID. As a consequence, the size of the RSA public key varies between 3*P and 6*P+32 bits, depending on whether ID based compression methods are used or not. If, in ECC, the curve and finite field information is shared, then the public key information consists of P+1 bits for the public point, assuming its y-coordinate is represented by a single bit, irrespective of the inclusion of user ID information. In a non-shared ECC setup, the finite field, random curve, and group order information take approximately 3.5*P bits, plus a small constant number of bits to represent a point of high order. Using a method similar to the one in 4.4 this can be reduced to an overhead (on top of the user ID) of, say, 48 bits (to generate the curve and finite field as a function of the user ID and 48 random bits) plus P/2 bits (for the group order information). Thus, non-shared ECC public key sizes vary between 49+1.5*P and 1+4.5*P bits. For XTR the public key size varies between 48+2*P and 5*P+Q bits if no digital signatures are required or 48+4*P and 7*P+Q otherwise, as described in 4.4 and 4.5.

ID based key generation methods for RSA affect the way the modulus and its secret factors are determined. The ID based approach for RSA is therefore viewed with suspicion and not generally used, despite the fact that no attacks on the methods from, for instance, [7] are known. For discrete logarithm based methods (such as ECC and XTR) ID based key generation methods affect only the part of the public key that is not related to the secret information, i.e., the way the public point is determined is not affected. The ID based approach is therefore commonly used for discrete logarithm based systems. This distinction between RSA on the one hand, and ECC and XTR on the other hand, should be kept in mind while interpreting the public key length data in Table 1.

4.6.2. Speed. In Table 1 speed is measured as approximate number of multiplications in a 170-bit field. RSA-encryption (or signature verification) with a 32-bit public exponent and a 6*P-bit field requires approximately 32 squarings and 16 multiplications in the field, which is assumed to be equivalent to approximately 0.8*32+16 multiplications, and thus about 36 as many, i.e., about 1500, multiplications in a 170-bit field. The number of operations required for RSA-decryption (or signature generation) is twice approximately 3*P squarings and 1.5*P multiplications in a 3*P-bit field, which amounts to about 11900 multiplications in a 170-bit field. For the ECC estimates we use the optimized results from [3], both for the two separate scalar multiplications in ECC-ElGamal encryption, and for the single scalar multiplication in ECC-ElGamal decryption and ECC-NR signature generation. The two scalar multiplications in ECC-NR signature verification can be combined, but it is as yet unclear if the methods from [3] can be used for this purpose. For that reason we use the estimate 2575 based on a rather straightforward but reasonably fast implementation; it is conceivable that this can be improved to, approximately, 2125 using the methods from [3]. The XTR estimates are based on 4.2, Remark 2.4.11, 4.3, and Remark 2.5.6.

The speeds given in Table 1 should not be confused with actual run times. Relatively speaking, actual run times for ECC and XTR should be close to the figures in Table 1. The performance of RSA may be somewhat better because in practical implementations a single 510-bit modular multiplication may be faster than nine 170-bit modular multiplications.

4.6.3. Signature and encryption size. For the encryption and digital signature sizes we assume a message consisting of m bits (including the redundancy) and, in 4.2, 4.3, and similar ECC applications, a symmetric encryption method using a 128-bit key. For RSA we assume that if the message is too long (to be encrypted or signed with message recovery using a single RSA application), then RSA is used in conjunction with the same symmetric encryption method.

4.6.4. Key generation. For RSA two independent 3P-bit primes have to be generated. For XTR either two independent P-bit primes (assuming z₂ as in 4.4 is allowed to be non zero), or two dependent P-bit primes (assuming Z₂ as in 4.4 is 0) have to be generated. In the former case XTR key generation may be expected to be about 3⁴=81 times faster than RSA key generation. In the latter case RSA and XTR key generation is about equally expensive for P=170: on the order of 2*(3P)⁴ bit operations for RSA, and on the order of P⁵ bit operations for XTR. ECC key generation is orders of magnitude slower and considerably more complicated than either RSA or XTR key generation.

TABLE 1

| | | | ECC | | XTR (non-shared only) | |
|---|---|---|---|---|---|---|
| | | RSA | shared | non-shared | no signing | with signing |
| Public key size | ID-based | 510 | 171 | 304 | 388 | 728 |
| | non ID-based | 1056 | 171 | 766 | 1020 | 1360 |

| | | | |
|---|---|---|---|
| Encryption speed | 1500 | 3400 | 4046 |
| Decryption speed | 11900 | 1700 | 2023 |
| Approximate encryption size | max(1024, 128 + m) | 171 + m | 340 + m |
| Digital signature generation speed | 11900 | 1700 | 2023 |
| Digital signature verification speed | 1500 | 2575 | 4046 |
| Approximate digital signature size | max(1024, 128 + m) | 170 + m | 170 + m |
| Key generation | two independent | curve with 170-bit | two 170-bit primes |
| | 510-bit primes | prime order subgroup | |

### 5. SECURITY

For completeness we sketch the straightforward proofs that traditional subgroup discrete logarithm and DH problems offer the same security as our versions. Let the notation be as in Section 2.

Lemma 5.1. Given y ε <g>, the discrete logarithm of y with respect to g can be found using a single call to an oracle that given a value v ε GF(p²) produces an integer a such that T(a)=v, if such an integer exists.

Proof sketch. Let y=g^{b} for some unknown integer b. Let a be the integer produced by an oracle call with v=y+y^{p-1}+y^{-p} ε GF(p²), then a=b, or a≡b*(p−1) mod (p²−p+1), or a≡−b*p mod (p²−p+1). Thus, b can be found be trying at most three different possibilities.

Lemma 5.2. Given v ε GF(p²) an integer a such that T(a)=v, if such an integer exists, can be found using a single call to an oracle that solves the discrete logarithm problem in <g>.

Proof sketch. Let v ε GF(p²). Determine the roots α, β, γ ε GF(p⁶) of the polynomial X³−vX²+v^{p}X−1 ε GF(p²)[X]. If α, β, γ ∉ <g> (which can easily be checked), then a with T(a)=v does not exist. Otherwise, assume without loss of generality that α ε <g≦, and use the oracle to produce an integer a such that g^{a}=α. This a satisfies T(a)=v.

Lemma 5.3. Given g^{a} and g^{b} for unknown integers a and b, the value g^{ab} can be computed using two calls to an oracle that given T(u) and T(v), for unknown integers u, v, determines T(uv).

Proof sketch. Given g^{a} compute its conjugates g^{a(p-1)} and g^{-ap} and T(a)=g^{a}+g^{a(p-1})+g^{-ap}. Similarly, compute T(b) and, using g^{a}/g=g^{a-1}, compute T(a−1). Determine T(ab) and T((a−1)b) using two calls to the oracle. Determine the roots α, β, γ ε GF(p⁶) of the polynomial X³−T(ab)X²+T(ab)^{p}X−1 ε GF(p²)[X]. We have that {α, β, γ}={g^{ab}, g^{ab(p-1)}, g^{-abp}}, but it is unclear which of α, β, γ is the value g^{ab} that we are looking for. For that reason we determine the roots α′, β′, γ′ ε GF(p⁶) of the polynomial X³-T((a−1)b)X²+T((a−1)b)^{p}X−1 ε GF(p²)[X]. We have that {α′, β′, γ′}={g^{(a-1)b}, g^{(a-1)b(p-1)}, g^{-(a-1)bp}}, so that g^{ab} can be determined as {α, β, γ} ∩ {α′*g^{b}, β′*g^{b}, γ′*g^{b}}.

Corollary 5.4. Given g^{a} and g^{b} for unknown integers a and b, the value g^{ab} can be found with probability ε/3 using a single call to an oracle that given T(u) and T(v), for unknown integers u, v, determines T(uv) with probability ε.

Corollary 5.5. Given g^{a} and g^{b} for unknown integers a and b, the value g^{ab} can be computed using a single call to an oracle that given T(u) and T(v), for unknown integers u, v, determines T(uv), and at most two calls to an oracle that asserts the correctness of the resulting value g^{ab}.

It follows from Corollary 5.5 that in many practical situations a single call to the T(u), T(v)→T(uv) oracle would suffice to find g^{ab} given g^{a} and g^{b}. As an example we mention DH key agreement where the resulting key is actually used after it has been established.

Lemma 5.6. Given T(u) and T(v) for unknown integers u, v, the value T(uv) can be found using a single call to an oracle that given g^{a} and g^{b}, for unknown integers a and b, determines g^{ab}.

Proof sketch. Determine the roots α, β, γ ε GF(p⁶) of the polynomial X³−T(u)X²+T(u)^{p}X−1 ε GF(p²)[X] and the roots α′, β′, γ ε GF(p⁶) of the polynomial X³−T(v)X²+T(v)^{p}X−1 ε GF(p²)[X]. We have that β=g^{u(p-1})^{ⁱ} and α′=g^{v(p-1)}^{^{j}} for unknown i,j ε {0, 1, 2}. From α and α′ determine g^{uv(p-1)}^{^{i+j}} using a single call to the oracle. Because the order of g divides p²−p+1 the sum of g^{uv(p-1})^{^{i+j}} and its conjugates equals T(uv).

### 6. EXTENSIONS

Methods similar to the ones described in this paper can be used for compact representation of and fast arithmetic with elements of a subgroup of order dividing p+1 in GF(p²)*, as used for instance in the public key system LUC (cf. [9]). For that application the savings obtained are smaller than in our application, and the resulting comparison to RSA and ECC is less favorable. For that reason we do not elaborate.

Instead of representing powers of g (and their conjugates) of order q dividing φ₆(p) by elements of GF(p²) as opposed to GF(p⁶), we can represent powers of elements of order dividing φ₃₀(p) by elements of GF(p¹⁰) as opposed to GF(p³⁰) using the same methods as presented in sections 2 to 5. Because 10+1=11 is prime (just as 2+1=3 is prime) we can use an optimal normal basis to represent the underlying field GF(p¹⁰), but the overall construction is more complicated and fewer suitable primes are available while no additional savings are obtained. The same holds for any integer x for which 2*x+1 is prime: powers of elements of order dividing φ_{6*x}(p) can be represented in GF(p^{2*x}) as opposed to GF(p^{6*x}), and the arithmetic with those powers in the field GF(p^{2*x}) is efficient. The case x=1, as described in detail in this paper, is the most efficient and most flexible of this more general construction. For that reason we do not present the details of the more general construction.

We are not aware of constructions similar to the ones described in this paper that obtain more savings than obtained by our construction. We have reason to believe that such constructions do not exist, but at his point this is merely a conjecture for which reasonable evidence seems to exist (cf. [2]).

### 7. REFERENCES

1. D. V. Bailey, C. Paar, Optimal extension fields for fast arithmetic in public-key algorithms, Proceedings of Crypto'98, LNCS 1462, 472-485, Springer 1998.
2. A. E. Brouwer, R. Pellikaan, E. R. Verheul, Doing more with fewer bits, Proceedings of Asiacrypt'99, LNCS 1716, 321-332, Springer, 1999.
3. H. Cohen, A. Miyaji, T. Ono, Efficient elliptic curve exponentiation using mixed coordinates, Proceedings of Asiacrypt'98, LNCS 1514, 51-65, Springer, 1998.
4. T. ElGamal, A Public Key Cryptosystem and a Signature scheme Based on Discrete Logarithms, IEEE Transactions on Information Theory 31(4), 1985, 469-472.
5. D. E. Knuth, The art of computer programming, Volume 2, Seminumerical Algorithms, second edition, Addison-Wesley, 1981.
6. A. K. Lenstra, Using cyclotomic polynomials to construct efficient discrete logarithm cryptosystems over finite fields, Proceedings of ACISP'97, LNCS 1270, 127-138, Springer, 1997.
7. A. K. Lenstra, Generating RSA moduli with a predetermined portion, Proceedings of Asiacrypt'98, LNCS 1514, 1-10, Springer, 1998.
8. C. P. Schnorr, Efficient signature generation by smart cards, Journal of Cryptology, 4, 161-174 (1991).
9. P. Smith, C. Skinner, A public-key cryptosystem and a digital signature system based on the Lucas function analogue to discrete logarithms, Proceedings of Asiacrypt'94, LNCS 917,357-364, Springer, 1995.

Although illustrative embodiments of the present invention, and various modifications thereof, have been described in detail herein with reference to the accompanying drawings, it is to be understood that the invention is not limited to these precise embodiments and the described modifications, and that various changes and further modifications may be effected therein by one skilled in the art without departing from the scope or spirit of the invention as defined in the appended claims.

1. A method of determining a public key having an optionally reduced length and a number p for a cryptosystem resident in a device that includes a memory, using GF(p) or GF(p²) arithmetic to achieve GF(p⁶) security, without explicitly constructing GF(p⁶), comprising:
selecting a number q and the number p such that p²−p+1 is an integer multiple of q;
selecting a number g of order q, where g and its conjugates can be represented by B, where F_{g}(X)=X³−BX²+B^{p}X−1 and the roots are g, g^{p-1}, g^{-p};
representing the powers of the conjugates of g using their trace over the field GF(p²); and
computing the public key as a function of p, q, and B.

2. The method of claim 2, further comprising:
generating a private key,
wherein the computing of the public key is a function of p, q, B, and the private key.

3. A method of encrypting a message using the public key generated by the method of claim 2.

4. A method of decrypting a message using the public key and the private key generated by the method of claim 2.

5. A method of signing a message using the public key and the private key generated by the method of claim 2.

6. A method of verifying a signature using the public key generated by the method of claim 2.

7. A method of key exchange using the public key and the private key generated by the method of claim 2.

8. A method of key exchange, such as a Diffie-Hellman key exchange, using the public key generated by the method of claim 1.

9. A system for determining a public key having an optionally reduced length and a number p for a cryptosystem resident in a device that includes a memory, using GF(p) or GF(p²) arithmetic to achieve GF(p⁶) security, without explicitly constructing GF(p⁶), comprising:
a processor for selecting a number q and the number p such that p²−p+1 is an integer multiple of q;
said processor selecting a number g of order q, where g and its conjugates can be represented by B, where F_{g}(X)=X³−BX²+B^{p}X−1 and the roots are g, g^{p-1}, g^{-p};
said processor representing the powers of the conjugates of g using their trace over the field GF (p²); and
said processor computing the public key as a function of p, q, and B.

10. The system of claim 9, further comprising:
said processor generating a private key,
wherein the computing of the public key is a function of p, q, B, and the private key.

11. A system of encrypting a message using the public key generated by the system of claim 10.

12. A system of decrypting a message using the public key and the private key generated by the system of claim 10.

13. A system of signing a message using the public key and the private key generated by the system of claim 10.

14. A system of verifying a signature using the public key generated by the system of claim 10.

15. A system of key exchange using the public key and the private key generated by the system of claim 10.

16. A system of key exchange, such as a Diffie-Hellman key exchange, using the public key generated by the system of claim 9.

17. A computer program article of manufacture for a cryptosystem resident in a device that includes a memory, comprising:
a computer readable medium for determining a public key having an optionally reduced length and a number p, using GF(p) or GF(p²) arithmetic to achieve GF(p⁶) security, without explicitly constructing GF(p⁶), comprising:
a computer program means in said computer readable medium, for selecting a number q and the number p such that p²−p+1 is an integer multiple of q;
a computer program means in said computer readable medium, for selecting a number g of order q, where g and its conjugates can be represented by B, where F_{g}(X)=X³−BX²+B^{p}X−1 and the roots are g, g^{p-1}, g^{-p};
a computer program means in said computer readable medium, for representing the powers of the conjugates of g using their trace over the field GF(p²); and
a computer program means in said computer readable medium, for computing the public key as a function of p, q, and B.

18. The article of manufacture of claim 17, which further comprises:
a computer program means in said computer readable medium, for generating a private key,
wherein the computing of the public key is a function of p, q, B, and the private key.

19. The article of manufacture of claim 18, which further comprises:
a computer program means in said computer readable medium, for encrypting a message using the public key.

20. The article of manufacture of claim 18, which further comprises:
a computer program means in said computer readable medium, for decrypting a message using the public key and the private key.

21. The article of manufacture of claim 18, which further comprises:
a computer program means in said computer readable medium, for signing a message using the public key and the private key.

22. The article of manufacture of claim 18, which further comprises:
a computer program means in said computer readable medium, for verifying a signature using the public key.

23. The article of manufacture of claim 18, which further comprises:
a computer program means in said computer readable medium, for performing a key exchange using the public key and the private key.

24. The article of manufacture of claim 17, which further comprises:
a computer program means in said computer readable medium, for performing a key exchange, such as a Diffie-Hellman key exchange, using the public key.

25. A business method of determining a public key having an optionally reduced length and a number p for a cryptosystem resident in a device that includes a memory, using GF(p) or GF(p²) arithmetic to achieve GF(p⁶) security, without explicitly constructing GF(p⁶), comprising the steps of:
selecting a number q and the number p such that p²−p+1 is an integer multiple of q;
selecting a number g of order q, where g and its conjugates can be represented by B, where F_{g}(X)=X³−BX²+B^{p}X−1 and the roots are g, g^{p-1}, g^{-p};
representing the powers of the conjugates of g using their trace over the field GF(p²); and
computing the public key as a function of p, q, and B.

26. The business method of claim 25, further comprising:
generating a private key,
wherein the computing of the public key is a function of p, q, B, and the private key.

27. A method of encrypting a message using the public key generated by the business method of claim 26.

28. A method of decrypting a message using the public key and the private key generated by the business method of claim 26.

29. A method of signing a message using the public key and the private key generated by the business method of claim 26.

30. A method of verifying a signature using the public key generated by the business method of claim 26.

31. A method of key exchange using the public key and the private key generated by the method of claim 26.

32. A method of performing a key exchange, such as a Diffie-Hellman key exchange, using the public key generated by the business method of claim 25.
